(19) United States
(12) Patent Application Publication
(10) Pub. No.: US 2025/0024977 A1
(43) Pub. Date: Jan. 23, 2025

(54) Systems and Methods to Enable Secure Exchange of Goods in Package Receptacles, and Remote Monitoring and Control of Package Receptacles and Its Surroundings

(71) Applicant: DOORBOX CORPORATION, FREMONT, CA (US)

(72) Inventor: Kumar Sundaresan, Fremont, CA (US)

(21) Appl. No.: 18/782,788

(22) Filed: Jul. 24, 2024

Related U.S. Application Data
(63) Continuation-in-part of application No. 17/561,998, filed on Dec. 27, 2021.
Application No. 17/561,998 is a continuation-in-part of application No. 16/140,271, filed on Sep. 24, 2018, now Pat. No. 11,206,939.
Application No. 16/140,271 is a continuation-in-part of application No. 15/294,254, filed on Oct. 14, 2016, now Pat. No. 10,083,561.
Application No. 15/294,254 is a continuation-in-part of application No. PCT/US2015/025194, filed on Apr. 9, 2015.
(60) Provisional application No. 63/528,447, filed on Jul. 24, 2023.
(60) Provisional application No. 63/157,798, filed on Mar. 7, 2021.
(60) Provisional application No. 63/215,481, filed on Jun. 27, 2021.
(60) Provisional application No. 62/631,854, filed on Feb. 18, 2018.
(60) Provisional application No. 62/588,019, filed on Nov. 17, 2017.
(60) Provisional application No. 62/569,442, filed on Oct. 6, 2017.
(60) Provisional application No. 62/568,261, filed on Oct. 4, 2017.
(60) Provisional application No. 62/342,980, filed on May 29, 2016.
(60) Provisional application No. 61/980,644, filed on Apr. 17, 2014.

(51) Int. Cl. A47G 29/14; A47G 29/30; G06Q 10/0836; G06Q 10/0837; G08B 13/02; H04N 7/18

(52) U.S. Cl. CPC A47G 29/141; A47G 29/30; G06Q 10/0836; G06Q 10/0837; G08B 13/02; H04N 7/181; A47G 2029/145; A47G 2029/147

(57) ABSTRACT

This invention involves a novel method, device, system, and apparatus to receive, return, or exchange goods and services at one's doorstep securely. The invention involves a novel security apparatus and a parcel receptacle connectable to any fixture, including to one or more parcel receptacles.

### CROSS-REFERENCE TO RELATED APPLICATIONS

This application claims priority under 35 USC § 119(e) to the following applications which are incorporated by reference for all purposes: PCT/US15/25194, filed in the USPTO on Apr. 9, 2015, which claims benefit to U.S. Provisional Patent Application Ser. No. 61/980,644, filed in the USPTO on Apr. 17, 2014, and US Continuation-in-part, non-provisional application Ser. No. 15/294,254, filed in the USPTO on Oct. 14, 2016, and U.S. Provisional Patent Application Ser. No. 62/568,261 filed in the USPTO on Oct. 4, 2017, and U.S. Provisional Patent application Ser. No. 62/569,442 filed in the USPTO on Oct. 6, 2017, and U.S. Provisional Patent Application Ser. No. 62/588,019 filed in the USPTO on Nov. 17, 2017, and U.S. Provisional Patent Application Ser. No. 62/631,854 filed in the USPTO on Feb. 18, 2018, and U.S. Non Provisional Patent Application Ser. No. 16/140,271 filed on Sep. 24, 2018, and U.S. Provisional Patent Application Ser. No. 63/157,798 filed on Mar. 7, 2021, and U.S. Provisional Patent Application Ser. No. 63/215,481 filed on Jun. 27, 2021, and U.S. Provisional Patent Application Ser. No. 63/528,447 filed on Jul. 24, 2024 and this application is also a continuation of invention associated with U.S. Pat. No. 9,364,112 issued on Jun. 14, 2016, U.S. Pat. No. 10,083,561 issued on Sep. 25, 2018 and U.S. Pat. No. 11,206,939 issued on Dec. 28, 2021.

### BACKGROUND

In the internet age, more and more consumers of the world rely on companies such as Amazon.com in the US, and many other online retailers in other parts of the World to shop, and to receive, return or exchange their parcels when they are away. They also depend on large carriers such as UPS, FedEx, DHL, OnTrack, etc. in the US, and similar popular carriers in other parts of the world. When the value of parcel increases and when the recipient is away, the delivery person often either chooses to leave a note at the front-door asking the recipient to collect the parcel at a later time from a nearby pick-up locations of the carrier or attempts to re-deliver at a later point. Both these options cause tremendous time delays and inconvenience and defeat the original objective of shopping online in a very time-efficient manner. Past attempts to solve the problem of receiving deliveries while the recipient is away at work or outside their temporary or permanent residences or place of their business have been unsatisfactory.

Additionally, many apartment complexes, hotels and other places of stay do not allow their residents to permanently alter or do anything outside their front door to help the resident(s) to securely receive, return or exchange parcels delivered by UPS, FedEx, DHL, On Track or any other mail carrier. In fact, many apartments, in the hope of offering their elite residents a clutter-free appearance in the hallway and/or exquisite living experience in their property, have very strict rules, and impose many restrictions for living. Residents are not allowed to leave anything outside their front-door for any extended periods of time, and property managers frown upon and even impose fines on residents or occupants who violate any of their strict rules.

### DOORBOX TRADEMARK

My US trademark application U.S. Ser. No. 87/294,209 has been allowed by USPTO for the use of the Trademark DOORBOX on Aug. 29, 2017. So, for the sake of brevity, the use of the word DOORBOX in this application may be referred, and it can mean 1) the invention described herein itself as a complete unit, or 2) the doorknob locking assembly which is connected to a doorknob securely, and/or 3) a parcel receptacle that is connected to the doorknob locking assembly via a secure cable, or 4) a parcel receptacle that is connectable to a fixed object or 5) a wireless, technology-enabled, parcel receptacle system that is tethered to a wired or wireless network of a parcel recipient or 6) or a parcel receptacle with a configured GPS module or an accelerometer type of device that detects tampering or dislocation of parcel receptacle by any unauthorized person. The word Doorbox in this application is intended to mean any or all combinations of one or more of the individual pieces/meanings indicated herein for the sake of brevity, to avoid complicated explanations of my invention every time it is referred in this application.

### ESSENTIAL FEATURES OF THIS INVENTION

Introducing the DoorBox, an AI-powered secure delivery solution designed to revolutionize secure home delivery and home security. This innovative system combines the latest advancements in Artificial Intelligence (AI), Internet of Things (IoT), and Machine Learning (ML) to ensure secure reception, storage, return, and exchange of parcels. Featuring an AI-Powered DoorMan, the DoorBox utilizes facial and image recognition, motion sensors, biometric authentication, and Bluetooth technology to provide robust security and convenience. Its integrated cameras, GPS, Wi-Fi, Bluetooth, alarms, and two-way audio systems facilitate seamless communication and real-time tracking, monitoring, and control from mobile and desktop applications. Additionally, it offers secure storage with temperature control to protect delivered items. The smart, automated system enhances security with tamper alerts, remote access, and personalized user interactions, making it an indispensable addition to every modern home, office, or any premises where secure delivery is needed. The goal is to offer peace of mind to people, and to reduce their anxiety of losing a package at home or office or avoid wasting time waiting in lines to receive something securely at a pharmacy, or restaurant or any store. This invention is expected to bring enormous peace of mind and happiness to people and offer time-saving alternatives for people. This is accomplished in the following ways:
a. I have invented a unique Parcel Receptacle with a significant number of features and advantages as outlined in the included Figures.
b. I have invented and incorporated important tethering mechanisms thereby the package receptacle itself is secured and cannot be easily stolen.
c. I have invented and incorporated important security features to protect the contents inside the package receptacles, and to enable viewing of them remotely.
d. I have invented and incorporated important security features for monitoring and controlling the package receptacle and its contents, and its surroundings remotely.
e. I have designed and invented our overall solution to provide all the above in the most economical and feature-rich ways. Our invention is also incorporated in a way that when the technology in a particular component is upgraded in the future (i.e. a 30 megapixel camera in the future may cost the same price as a 2 megapixel camera today, and so a design that is conducive of a quick replacement of an electronic part of its enclosure (146) would be an attractive feature for mankind), the pieces inside our parcel receptacle can be easily upgraded just by swapping the necessary components or its enclosures without needing to throw and replace the entire parcel receptable or system, thereby offering enormous cost savings, while it promises to maximize utility, and minimize wastage of materials to save the planet earth from environmental pollution. Technology keeps getting upgraded and more features are available for less and less cost as time goes by, and so having a design that offers a quick swap of essential components is a benefit to humans and helps create a green planet.

### SUMMARY OF THE INVENTION

This is a continuation of my invention patented in U.S. Pat. No. 9,364, 112 issued on Jun. 14, 2016, and U.S. Pat. No. 10,083,561 issued on Sep. 25, 2018, and U.S. Pat. No. 11,206,939 to be issued on Dec. 28, 2021, to address the growing need to securely receive, return or exchange parcels or services in a secure manner. None of the existing inventions in my opinion adequately addresses all of the limitations and constraints for practical implementations. In addition, none of them include many of the features of my invention. The various embodiments of the present invention utilize fixed objects such as doorknobs or door handles or door knockers or door or any kind of object that exist near the front door of a residence or business or any place of stay or proximate to the parcel address of a recipient. In apartment complexes, if the property owner prefers, my invention can be connected to a bicycle stand or any other stationary stand or object or rack to which my invention can be securely connected, and every resident can be allowed to put their parcel receptacle, with their apartment numbers or other user-identifiable information, so that the delivery carrier can deliver everyone's parcel to their respective recipient in a secure manner. Even in individual houses, this cable assembly can be connected to grills or fixtures of any sort, which are amenable to be circled around with a cable and locked to secure the parcel box. My invention can also be used if a property manager chooses to install a handful of my DOORBOX in a convenient place in their property to facilitate their residents receive their respective parcels safely and securely.

The entire assembly or apparatus, which includes a novel security apparatus and/or a parcel receptacle, can be quickly and easily, attached or detached to fulfill its intended function. A locking mechanism in a parcel receptacle allows the delivery personnel to deliver the package so that only the intended recipient can have access to the parcel. In cases where a customer or owner of the system/apparatus described in this invention wants to return parcel, only authorized agent or authorized personnel can access the parcel in the parcel receptacle by utilizing one or more of secure unlocking mechanisms described elsewhere in this invention. An audible alarm with a speaker can be configured to deter any attempted unauthorized tampering of parcel receptacle. The various embodiments use flexible or rigid or semi-rigid parcel receptacle of varying sizes to accommodate receipt of most common sizes of packages to suit typical shopping needs. Additionally, the parcel receptacle may be fixed in size, or may optionally have or employ an extension mechanism wherein the size and volume of the parcel receptacle can be increased or decreased to accommodate various sizes and needs of parcels. Additionally, to enable multiple deliveries or returns of parcels in each day by multiple delivery personnel or carriers, multiple parcel receptacles, or parcel receptacles with multiple compartments with multiple individual access mechanisms to each compartment, can also be configured to be connected securely so as to fulfill the intended objectives.

Additionally, parcel receptacles can be tethered to an authorized parcel recipient by physical means or by electronic or technological means. The tethering option involving physical means can be comprised of tamper-proof cables, a locking assembly in a number of configurations described elsewhere in this application, or the tethering option can involve electronic and/or technological means such as connectivity to the wired or wireless network of the parcel recipient or by means of configurable GPS module present in the parcel receptacle which can detect dislocation or tampering of parcel receptacle by any unauthorized individuals by sensing one or more of configurable events of tamper detection.

### DESCRIPTION OF THE DRAWINGS

FIG. 1a shows an example of a typical circular doorknob.

FIGS. 1b, 1c, and 1d shows examples of typical straight-shaped doorknobs and a door handle.

FIG. 1e shows an example wall mount that can be secured to any place so that wall mount can be used as a stationary object to secure the DoorBox. FIG. 1e shows examples of how a parcel receptacle can be tethered (166) into a wall mount with a lock assembly or shows how a parcel receptacle can be tethered into a wall mount (161) directly.

FIG. 1f shows a typical circular doorknob. In my invention as described and explained in many of the figures to follow, there are many features, and some are essential features, and some are optional features. For example, the locking mechanism of a doorknob locking assembly that can be securely connected to a doorknob may utilize a simple lock and key mechanism (FIG. 2a, Part 107), or may involve a more hi-tech feature/solution (FIG. 13a) based on Bluetooth, or RFID, or Mobile-phone based application, or NFC-based technology, or a finger-print reader, etc. to authenticate and authorize individuals. However, to avoid complication of explanations resulting from multitude of permutations and combinations, mostly, explanations is only directed toward a physical solution as it is obvious and common knowledge what the other parts can perform when included. For example, it is common knowledge that a fingerprint reader, when included in an embodiment, can be utilized to read a fingerprint and authenticate an authorized individual. Similarly, several other features of various parts and components, are obvious and common knowledge based on the inclusion of such part or part description, and for the sake of brevity, they are not explained in detail as their use and application are fairly straight forward and common knowledge, and will be easy to understand for anyone familiar with the art.

FIG. 2a shows the cartridge (105) of the lock assembly which varies in geometry and dimensions to suit different types of doorknobs and fixtures. The security apparatus (106) houses these cartridges and serves as the primary structure for securing the mechanism. The key barrel or tubular lock (107) is prominently featured, allowing for the insertion and turning of a key to lock or unlock the system.

FIG. 2b shows a tubular lock (107) on the locking assembly.

FIG. 2c shows the locking cartridge (105), which is designed to be inserted into the main body of the security apparatus. The screws (109) are used to securely hold the cartridges in place, ensuring the structural integrity and proper function of the locking system.

FIG. 2d show the many female threads (110) where the screws (109) are screwed into the top and bottom bases. There are many threads so that distances between cartridges can be adjusted to help securely connect to various dimensions and geometry of doorknobs, fixed objects or fixtures.

FIGS. 3a and 3b show some examples of how metal cartridges and screws which could scratch the doorknobs or stationary fixtures can be avoided by replacing them with rubber like material or some strong engineering plastics. This helps to potentially avoid scratching the surface of doorknobs or fixtures.

FIG. 4a illustrates a secure parcel delivery system featuring a typical circular doorknob (101) and a straight-shaped doorknob (102) as part of its locking mechanisms. The main parcel receptacle (117) is robust and designed to store various types and sizes of packages. An IOT electronics enclosure assembly (118) houses technological component securely. A cut-resistant cable (129) tethers the parcel receptacle to a stationary object (160), ensuring enhanced security. This setup combines standard doorknobs, a secure container, and strong tethering to create a reliable parcel delivery and storage system.

FIG. 4b illustrates a secure parcel receptacle system mounted on a stationary object. The primary components include a wall mount (161) affixed to a stationary plane (160), supporting a security apparatus (106) which features a tamper-proof locking mechanism. The receptacle (117) is tethered to the security apparatus using a cut-resistant cable (129), ensuring the parcel's safety. Additionally, the setup includes advanced security measures such as a camera and potentially other electronics housed within the receptacle to provide real-time monitoring and alerts. This configuration ensures that parcels are securely locked and monitored, preventing unauthorized access and tampering.

FIG. 4c depicts a secure parcel receptacle system, comprising a wall mount (161) attached to a stationary plane (160). The receptacle (117) is securely fastened to the mount using a cut-resistant cable (129), providing robust protection against unauthorized removal. The security apparatus (106) ensures the integrity of the locking mechanism, safeguarding the contents of the receptacle.

FIG. 5a shows the image displays a mobile app interface for “My DoorBox,” a system for managing a secure parcel receptacle. The interface shows status indicators for Wi-Fi signal strength, battery level, and internal temperature. It includes a section to update the controller password, with fields to enter the current and new passwords, each with an eye icon to toggle visibility. A prominent “Update” button is provided to save changes. The bottom navigation bar features icons for accessing the main dashboard, home screen, and images captured by the receptacle's cameras. The design is clean and user-friendly, facilitating efficient monitoring and management of the DoorBox system.

FIG. 5b shows the DoorBox mobile application designed for remote monitoring and control. The dashboard displays real-time parameters, including lock status and delivery notifications. The Box Status feature shows the lock status as Unlocked with a timestamp, while the Internal Camera provides a live feed of the box contents, displaying package tags like CVS Pharmacy and Chewy store. Users can manage notification preferences and view recent delivery alerts. Navigation icons at the bottom ensure easy access to other app sections, enhancing user convenience and security.

FIG. 5c illustrates a mobile application interface for a smart parcel receptacle system. The interface features live feeds from both an internal camera and an external camera. The internal camera captures the contents of the parcel receptacle, displaying packages from CVS Pharmacy and Chewy.com, ensuring that the user can verify delivered items. The external camera provides a live view of the delivery area, showing a delivery person with a package. This dual-camera system allows for real-time monitoring of both the interior and exterior environments, enhancing security and providing peace of mind to the user.

FIG. 5d image showcases the user interface of the Door Box mobile application, designed for managing and monitoring the Door Box parcel receptacle. The interface is divided into several functional sections. The Action section allows users to control the current status, alarm, and motion detection, each with an on/off toggle switch. The Box State section provides real-time information on Wi-Fi connectivity, battery level, and temperature inside the Door Box, displayed as percentages and a Fahrenheit temperature reading, respectively. At the bottom, navigation icons for My DoorBox, Home, and Images facilitate easy access to different app sections.

FIG. 6a shows the invention pertains to a parcel receptacle, known as DoorBox, designed for secure package delivery and storage. The DoorBox features a top lid (120) that securely encloses the contents, ensuring easy access while maintaining security. Inside, it accommodates packages (132) of various sizes. A continuity cable (123) signals any tampering or unauthorized actions, enhancing the security of the receptacle. Additionally, the DoorBox includes a compressible cushion (139) that adjusts based on the weight of the packages: heavier packages compress the cushion and sit lower, while lighter packages remain on top. This design improves accessibility, allowing users to retrieve lightweight items without deep bending.

FIG. 6b illustrates a Door Box featuring a parcel receptacle (117), an IoT electronics enclosure assembly (118) that holds various components together, an illumination or light source (137), a solar panel for power supply (144), and an enclosure for technological components (146). This design ensures secure and efficient storage with integrated lighting and sustainable power.

FIG. 6c provides a detailed view of the Door Box system with the lid open, revealing its internal components. The parcel receptacle (117) is shown with the top lid or door in an open position, secured by a locking latch (119) that ensures the lid remains closed when necessary. Gas struts (142) are attached to the sides of the lid, facilitating smooth opening and closing operations. The control interface, including a display panel and interactive elements, is housed within an IoT Electronics enclosure assembly (118) on the front of the box.

FIGS. 6d and 6e depicts the exterior view of the Door Box system, focusing on its key external components. The illumination source (137) is mounted on top, providing lighting for visibility and security purposes. The solar panel (144) is integrated into the top surface, serving as an energy source to power the system, ensuring sustainability and independence from external power supplies. The IoT electronics enclosure assembly (118) houses the control interface, including a display and other interactive elements for user input.

FIG. 7a provides a detailed internal view of the Door Box system with its lid open, highlighting several key components. The top lid or door (120) is shown in the open position, revealing the internal electronic enclosure (146) mounted on it. This enclosure consists of various IoT electronics components, including an Internal camera 1 (163) and Internal camera 2 (164) for monitoring the multiple compartments inside the box.

FIG. 7b image shows a Door Box with part (141) indicating a compartment for storing beverages or food, part (146) representing an enclosure for IoT Electronics enclosure components, and part (120) depicting a top or front lid that serves as a door to access the compartments. The design ensures secure and temperature-controlled storage of items.

FIG. 7c image shows a Door Box with key components part (141) is for storing beverages or food, part (143) is an ice pack for cooling, and part (162) is a Peltier module for additional temperature control, ensuring items are kept at the desired temperature during storage.

FIG. 7d depicts the Door Box system with its lid open, providing a clear view of the internal components and structure. The top frame (134) supports the lid, which is equipped with an internal electronic enclosure (146) that houses various control and monitoring components. Inside the box, there is a hot insulated container (175) and a normal insulated container (174), designed to keep packages at the desired temperature. Additionally, a cold insulated container (177) is present for items requiring refrigeration. The keypad interface (135) is integrated into the front panel, allowing users to enter access codes. The IoT electronics enclosure assembly (118) houses the display panel and other interactive elements for user input. This figure highlights the versatile storage options and advanced control features of the Door Box system, ensuring secure and efficient management of various types of packages.

FIG. 8a depicts the front view of the Door Box system, highlighting key components crucial for its operation. An external antenna (124) is mounted on top, enhancing wireless communication capabilities. The top lid or door (120) serves as the primary access point for placing and retrieving packages. Integrated into the front panel is a display panel (111), which provides users with information and status updates about the Door Box system. Additionally, an IoT Electronics enclosure assembly (118) houses the control interface, including buttons and possibly other interactive elements for user input.

FIG. 8b illustrates a parcel receptacle with several integral components designed for enhanced security and functionality. Component (106), the security apparatus, is used to physically tether the parcel receptacle to a stationary object, providing tamper-proof security through a cable or physical means. The louvers, labeled as (121), allow for controlled airflow and light while offering protection from the weather and maintaining privacy. The physical antenna, denoted as (124), is essential for wireless communication, facilitating the transmission and reception of electromagnetic waves. The cut-resistant cable, identified as (129), provides strength and security, being resistant to cutting attempts. Lastly, the anti-theft eye bolt, marked as (183), the bolt connects the Door Box to a stationary object using a rope or chain, features a reinforced eye and tamper-proof mechanism for secure fastening to the backside of the receptacle.

FIG. 9a depicts the exterior view of a closed-Door Box system, highlighting its main components. The box features a top lid or door (120) that serves as the primary access point for placing and retrieving packages. The IoT Electronics enclosure (138) is mounted on the front of the box, providing users with information and status updates about the Door Box system. The main body of the box (168) is designed to securely store packages, ensuring they are protected until retrieved. The idea is that DoorBox will own and manufacture the part 138, which is the brain of the entire DoorBox product, and we can outsource all the rest of box manufacturing to suppliers who are specialist in manufacturing of boxes. This way, we will own the critical technology part of our product ourselves and can outsource the rest of the physical box parts to other manufacturers in different regions to partner and scale quickly deployments of DoorBox. The same concept holds true for the embodiment shown in FIG. 14a through FIG. 14d also which houses critical electronics components inside part 118 on the top of the lid. Conceptually, we will own the critical IoT components that are inside part 118 and outsource manufacturing of the rest of the boxes that does not have critical technology or valuable data.

FIG. 9b depicts the exterior view of a closed-Door Box system, highlighting its key components. The box features a front lid (120), which serves as the primary access point for placing and retrieving packages. IoT Electronics enclosure (138), which provides information and status updates about the Door Box system.

FIG. 9c illustrates an open-Door Box system, showcasing its internal components and structure. The camera (136) facing outside is positioned to capture the delivery personnel upon opening of the lid. The motion sensor (149) is included for detecting motion, enhancing the system's security features and the locking latch ring or hook (119) Female lock pin for securing the hook closure (153). The box's internal space (168) is designed to accommodate packages securely.

FIG. 9d illustrates a close-up view of the IoT Electronics enclosure for the Door Box system. The control interface includes several key components, such as a camera (112) positioned to capture images or videos for monitoring and security purposes. Additionally, there is a display (111) that provides information and status updates about the Door Box system. These components are housed within an IoT electronics enclosure assembly (118), which protects and secures the various elements of the control interface, ensuring they are securely mounted and functioning properly.

FIG. 10a illustrates a detailed view of a multi-unit secure package delivery system using the same fundamental concept that are present in a single-unit Door Box setup. The system features multiple compartments labeled DOORBOX-1 through DOORBOX-9, designed to securely receive and store packages. The compartments are divided into two sections, each containing several individual lockers. One section includes a compartment with an integrated access control interface and external camera (165), which likely allows for user identification and secure access to the stored packages. A master control DoorBox (176) is mounted on the side of the system and consists of a main display unit through which all individual boxes can be controlled and accessed. This configuration ensures that packages are securely stored and accessible only to authorized individuals, providing an efficient and secure solution for multi-unit package delivery and storage.

FIG. 10b similarly depicts a restaurant with an integrated multi-unit Door Box system. The image shows a rack-type parcel receptacle setup (157), consisting of multiple small and medium-sized compartments (158) designed to securely receive and store packages. This configuration allows the restaurant to manage deliveries efficiently, ensuring that all packages are stored securely until retrieved. The placement of the parcel receptacle system outside the restaurant highlights its accessibility and convenience for delivery services.

FIG. 11a illustrates a simplified version of our high-performance, highly optimized IoT architecture designed for securely receiving packages and deliveries via the Door Box system. At the top, the system is driven by the DoorBox Mobile-App (1) and supported by cloud storage (2), which encompasses the DoorBox Server (3), image processing/AI/ML (4), a database (5), and a file system (6). The architecture connects to the Internet via a Wi-Fi module (7) and/or an machine-to-machine (M2M) chip (8).The system features two main micro-controllers: a lower power-consuming micro-controller (MC-A) (9) and a higher processing power micro-controller (MC-B) (10). MC-A handles one or more of the always-on functions in Block-A, which includes the motion sensor (11), touchpad activity (12), gyro door lid sensor (13), accelerometer (14), tampering/wire discontinuity detection (15), real-time clock (16), GPS (17), and RFID (18). Block-B, managed by MC-B, is triggered on demand and controls the internal camera (19), external camera (20), lock/unlock (21), alarm (22), SD card (23), display (24), internal LED light (25), and external LED light (26). An on/off wakeup switch (27) mediates between the two blocks, while the energy system (28) comprises a battery (29), battery charger (30), power supply (31), and/or a solar panel (32). This architecture ensures that the Door Box system operates efficiently, securely, and sustainably, managing both continuous and on-demand functions seamlessly.

FIG. 11b depicts a typical delivery scenario involving the Door Box system. At the top of the illustration is a delivery truck (131), representing the transportation vehicle used for parcel delivery. Below the truck, a delivery person (130) is shown carrying a package (132), indicating the process of delivering the parcel. At the bottom of the illustration is the Door Box system, with the parcel receptacle (117) designed to securely receive and store delivered packages. The system includes an external antenna (124) for enhanced wireless communication. This figure highlights the interaction between the delivery person, the delivery truck, and the Door Box system, showcasing the secure and efficient handling of parcel deliveries.

FIG. 11c depicts a delivery scenario involving the Door Box system. At the top, a delivery truck (131) is shown, representing the vehicle used for transporting packages. Below the truck, a delivery person (130) labeled as an “Amazon Truck Driver With package” is carrying a parcel. At the bottom, the Door Box system is displayed with its parcel receptacle (117). The receptacle's lid is open, and the locking latch (119) is visible, indicating the secure mechanism for storing packages. This figure highlights the interaction between the delivery personnel and the Door Box system, emphasizing the secure receipt and storage of delivered packages.

FIG. 11d illustrates the workflow of the Door Box system's AI processing mechanism. The diagram shows the integration of various AI programs, such as GEMINI, ChatGPT, or any other AI program, interfacing with the system through a dynamic API. The workflow is divided into three main stages: input, processing, and output. In the input stage, the system collects various forms of data, including images, text, audio, and videos. This data is then processed by the dynamic API using the AI programs. Finally, the processed information is displayed on the DoorBox display, showing relevant information such as the status “DoorBox Unlocked.” This figure highlights how advanced AI and dynamic APIs work together to process multiple data types from illustrations as shown in FIG. 11b and FIG. 11c can work together seamlessly, and deliver actionable outputs, ensuring efficient and intelligent management of the Door Box system.

FIG. 11e illustrates the real time analysis capabilities of Chat GPT's generative AI within the Door Box system, showcasing how the AI processes and interprets package information from images from internal camera that captures images of packages delivered inside DoorBox. In the input section, two images are displayed: the first image contains packages from FedEx, UPS, and Walmart, while the second image includes packages from CVS Pharmacy and Chewy.com. The output section presents the AI's detailed analysis for each image. For the first image, DOORBOX.ai identifies three packages and provides sender information: FedEx Express, UPS, and Walmart.com. The AI's image description elaborates on the visual characteristics of each package, including color and branding details. For the second image, DOORBOX.ai identifies two packages and provides sender information: CVS Pharmacy and Chewy.com, with the image description highlighting the branding and color of the packages. This figure demonstrates the AI's proficiency in accurately analyzing and describing package details, thereby enhancing the Door Box system's functionality by providing detailed insights into the received parcels.

FIG. 11f shows the DoorBox automatically unlocking when a pre-authenticated delivery person approaches a GPS-enabled DoorBox. The system will notify the DoorBox about the delivery, triggering the automatic opening feature.

FIG. 11g illustrates the advanced AI processing system used in the Door Box. The system accepts various input types, including text or barcode, image, video, and audio. These inputs are processed by advanced AI programs such as GEMINI, Chat GPT, or any other AI program. The outputs, after processing, can be in the form of text or barcode, image, video, or audio. This diagram emphasizes the versatility and capability of the AI processing system in handling multiple input and output formats to enhance the functionality and application of the Door Box to suit in a variety of circumstances. Since the power of AI has reached unimaginable heights of sophistication, processing rich feeds of data from DoorBox can result in utilization of DoorBox in multiple applications very efficiently.

FIG. 12a illustrates the components of the Door Box system. The left side panel (181), right side panel (178), front side panel (180), and top lid or door (179). The bottom side panel (133) serves as the base. Gas struts (142) facilitate the opening and closing of the top lid or door. The back side panel includes a handle (126) for access. This figure provides a clear view of the structural elements and their assembly in the Door Box system.

FIG. 13a illustrates the control module of the Door Box system, highlighting key components essential for its operation. A camera (112) is integrated for visual monitoring and security. The wireless sensor (114) enables wireless communication for remote monitoring and control. The fingerprint or biometric reader (113) provides secure access control. The keypad interface (135) allows users to enter codes to unlock the system. The inner case part (125) supports the structure, housing various electronic components. The motion sensor (149) is included for motion detection. A 2-way audio device (128), consisting of a microphone and speaker, enables communication with individuals near the Door Box.

FIG. 13b provides an external view of IoT electronics enclosure. The display panel (111) is visible, which can be used to communicate lock or unlock codes and display various messages such as alerts and notifications. The motion sensor (149) is included for motion detection, enhancing security by detecting unauthorized access attempts. A buzzer or audio signaling device (170) is present to emit alerts in case of security breaches. The visual display of signals (115) indicates the status of the system, such as armed or disarmed states and battery levels. A key (154) to secure the enclosure (146) from tampering is enclosed within the module, managing the electronic functions. The door of the electronic enclosure (155) provides access to the internal components for maintenance and updates. This setup ensures that the Door Box system remains secure, monitored, and easy to manage.

FIG. 13c represents key (154) to secure the enclosure (146) from tampering. This enclosure contains many electrical and electronic hardware, which manage the system's electronic functions. The door of the electronic enclosure (155), providing access to the internal components. An illumination source (137) is integrated within the enclosure, ensuring visibility of the internal components. An ultrasonic sensor (172) is present, used to measure distances and detect the presence of packages inside the Door Box. An inside-facing camera 1 (163) and an Inside camera 2 (164) are included for monitoring the interior environments, respectively. This configuration demonstrates the comprehensive design of the Door Box system, incorporating advanced sensors, cameras, and lighting to ensure secure and efficient parcel management.

FIG. 13d features an advanced vibration sensor (147) for detecting tampering or unauthorized access. The electronic board (145) contains the necessary hardware components and connections. A magnetic lock (151) is shown, which secures the system and can be electronically controlled. An illumination source (137) ensures the internal area is well-lit, while the SIM card and holder (171) provide cellular connectivity. A connection source of electrical power (173) is included for powering the system. The battery (169) supplies power to the electronic components, ensuring continuous operation. An additional electronic lock (150) enhances security. The inner case part (140) supports the structural integrity of the enclosure, keeping all components securely in place.

FIG. 13e provides an intricate view of the internal electronics and structural components of the Door Box system. This figure highlights several critical parts within the electronic enclosure. An advanced vibration sensor (147) is integrated to detect any unauthorized tampering. The GPS module (127) is present for location tracking. A sound sensor (148) is included to detect and respond to unusual noises. The enclosure houses a SIM card and holder (171) for cellular connectivity, ensuring the system remains connected even in remote locations. A printed circuit board (156) manages the electronic functions. Additionally, a buzzer or beeper (150) is provided to alert in case of tampering. The inner case part (125) supports the structural integrity of the enclosure, ensuring all components are securely housed.

FIG. 13f provides a detailed view of the internal components and structural features of the Door Box system. This figure shows the electronic enclosure with its door (155), revealing the internal layout. Inside, an illumination source (137) is visible, providing necessary lighting within the enclosure. An inside-facing camera (163) is also present to monitor the internal contents and activities. The emergency unlocking procedure for electronic failure involves using a backup key (182).

FIG. 13g illustrates the exterior view of an advanced locking mechanism integrated into the Door Box system. The limit switch (159) is shown on the top, likely used to detect the door's position or status. An inner case part (125) is visible, providing structural support for the internal components. The figure also features a keypad interface (135), allowing users to enter access codes to unlock the system. Additionally, an external camera (165) is mounted, enabling visual monitoring of the area around the Door Box

FIG. 13h illustrates an internal view of the Door Box system, highlighting key electronic and structural components. The figure shows the intricate layout within the parcel receptacle's control unit. A limit switch (159) is present, which is likely used to detect the position of the door or other moving parts. An advanced lock system (167) is integrated, comprising both electronic and mechanical components for enhanced security. The enclosure for the alarm unit (122) houses the alarm mechanism that can trigger alerts in case of tampering. A buzzer or audio signaling device (170) is installed to produce audible alerts. A battery or other energy source (169) powers the electronic components. Additionally, a printed circuit board (152) is visible, containing various electronic parts essential for the operation of the Door Box system. This detailed view underscores the sophisticated design and functionality of the system, ensuring secure, monitored, and efficient parcel management.

FIG. 14a Illustrates an embodiment of the Door Box system, highlighting the main structural components. The parcel receptacle (120) is depicted with its front door closed, which is equipped with a handle or knob (126) for easy opening and closing. On top of the receptacle, an IoT electronics enclosure assembly (118) houses the control. This configuration provides a secure and efficient solution for parcel receptacle and storage, integrating advanced electronic features for user interaction and system management.

FIG. 14b illustrates a parcel receptacle equipped with several crucial components to ensure security and functionality. Component (120), the front lid or door serves as the primary access point for parcel insertion and retrieval. The louvers, labeled as (121), provide necessary ventilation and airflow while safeguarding the interior from external elements. The physical antenna, denoted as (124), facilitates wireless communication by transmitting and receiving signals essential for device connectivity. An anti-theft eye bolt, identified as (183) the bolt connects the Door Box to a stationary object using a rope or chain is mounted on the backside, featuring a reinforced eye and tamper-proof mechanism for enhanced security. The handle or holder (126) facilitates easy lifting or movement of the parcel receptacle.

FIG. 14c Illustrates an embodiment of the Door Box system with a detailed view of its internal components and structure. The parcel receptacle is shown with its front door open, providing a clear view of the interior. Inside, the receptacle features an inside-facing camera (163) positioned to monitor inside the box. A locking latch (119) is integrated into the front door (120) to secure it and prevent unauthorized access. (137) represents an illumination light. One or more of these can be present both inside and outside the parcel receptacle. The front door (120) serves as the primary access point for placing and retrieving parcels, and it is designed to open wide to facilitate easy access.

FIG. 14d Illustrates an embodiment of the Door Box system with a focus on the structural and electronic components. The figure shows the parcel receptacle with an open front door, revealing the internal structure. The receptacle includes an IoT electronics enclosure assembly (118) mounted on the top, control interfaces and electronic components. An external antenna (124) is mounted on the top of the receptacle to enhance wireless communication capabilities, ensuring reliable connectivity for monitoring and control. The front door of the receptacle features a handle or knob (126) to facilitate opening and closing.

### FEATURES AND INTENDED FUNCTIONALITIES OF COMPONENTS AND THEIR USAGE REFERENCES

There are many parts that make up this invention. Most of the key parts and key electronics are explained below. However, there are many generic parts that are necessary and common, such as screws, nuts, wires, capacitors, resisters, electronic relays, etc., and that are needed in most applications of this nature and those are considered obvious, and not all of them can be realistically listed here, and those are obvious to people who are familiar with the art and does not require special mention. Here is an overview of some of the key parts and features.

Doorknobs or Door handles or Door Knockers or Any Stationary Object: The physical tethering of a parcel receptacle may involve utilizing doorknobs and/or door handles or wall mounts (161), door knockers or doors. However, it is important to note that any existing stationary object present, that is conducive to be utilized in a meaningful way with the mentioned security apparatus, is expected to be utilized for achieving the intended purposes of this invention. So, when a doorknob or door handle or door knockers or door is referenced, it is understood that any other object or any stationary object, which can potentially be utilized like a doorknob or door handle or door knockers or door, is automatically included for the purposes of this invention, although the words such as “any other object” or “any other stationary object”, may not be referenced explicitly each time. These doorknobs are mentioned as part 101, 102, 103 in various figures.

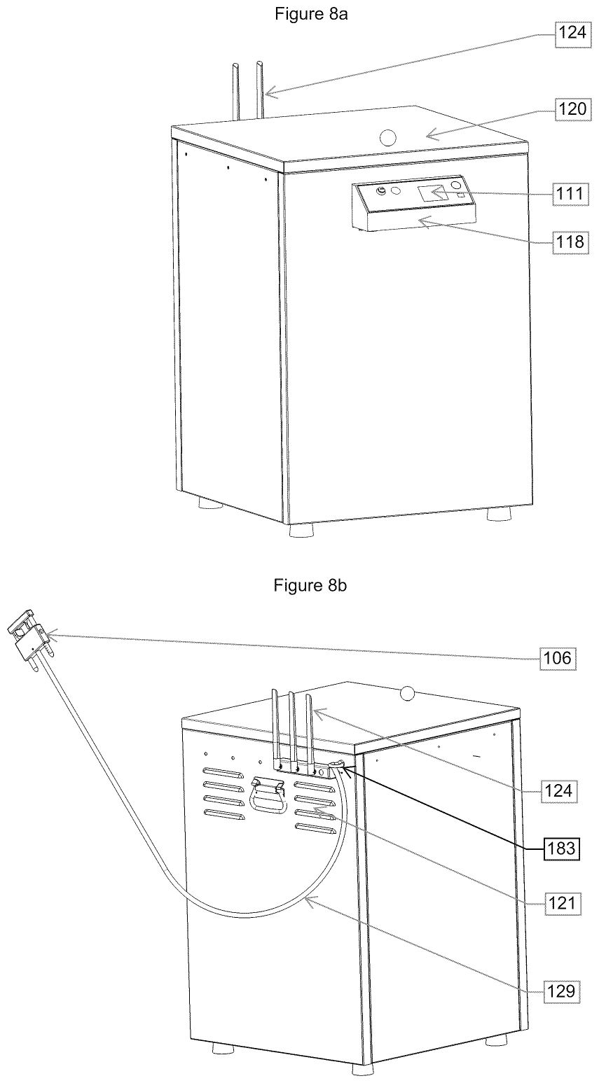

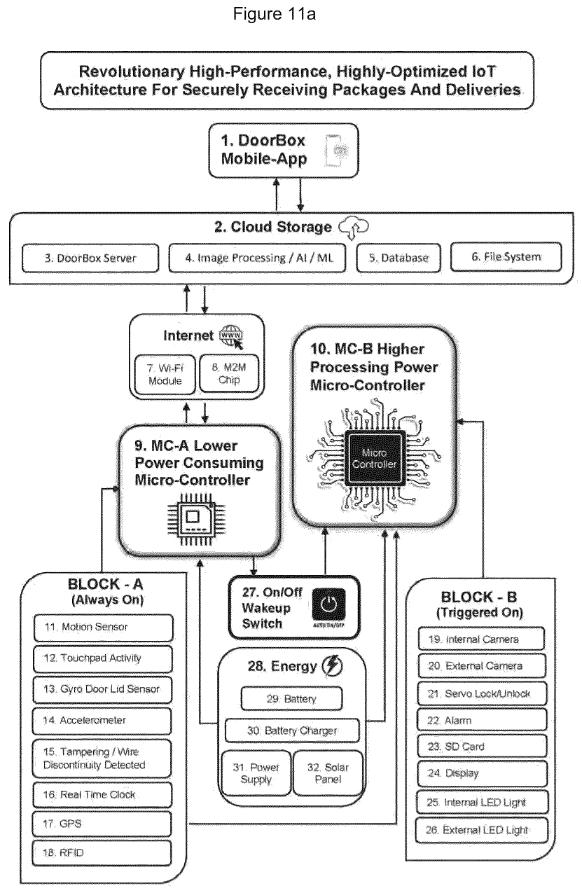

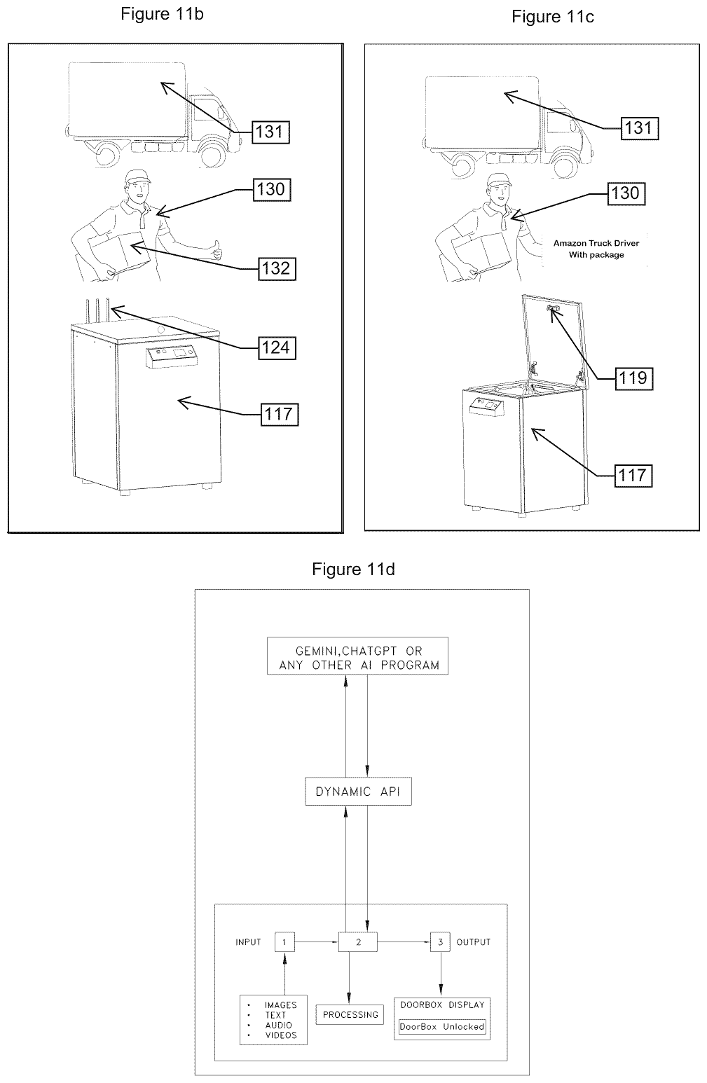

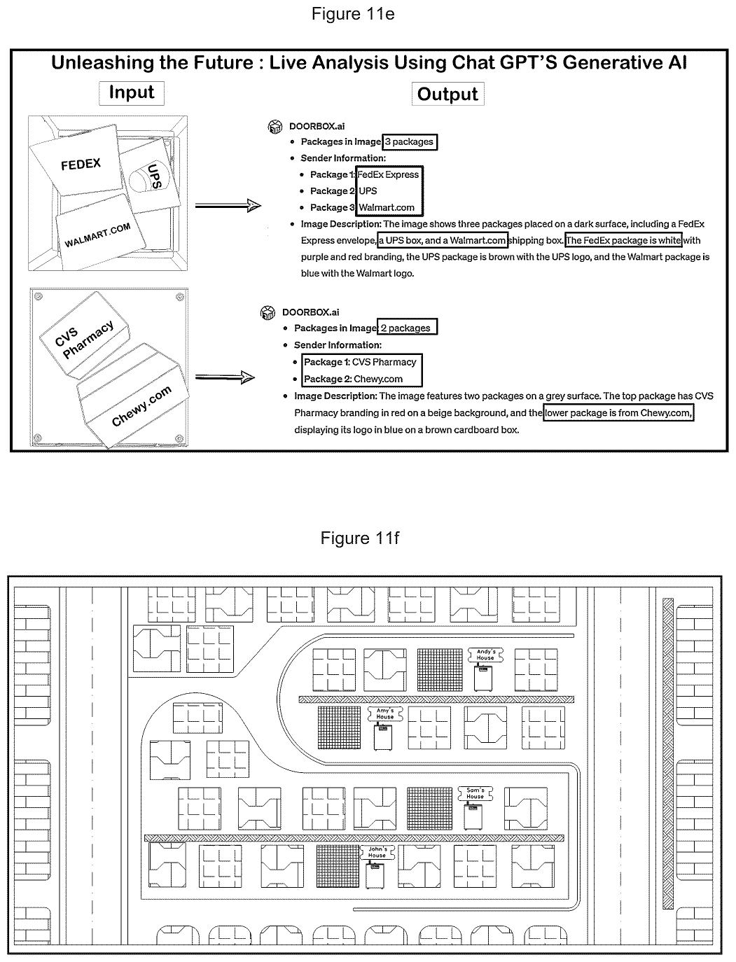

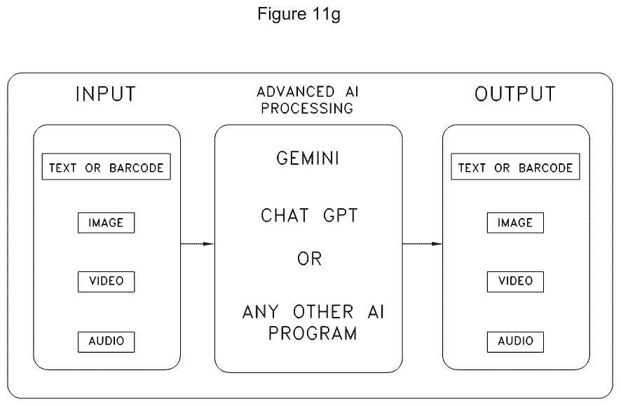

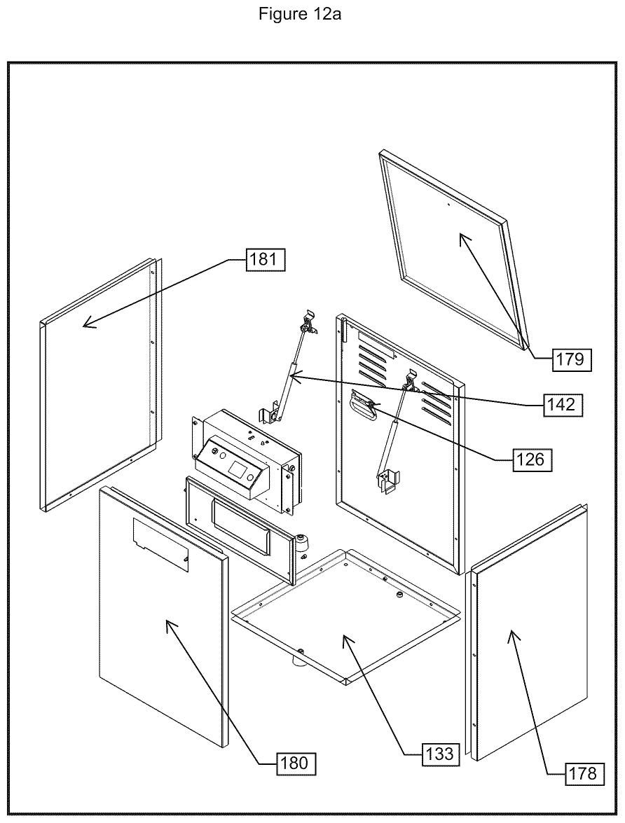

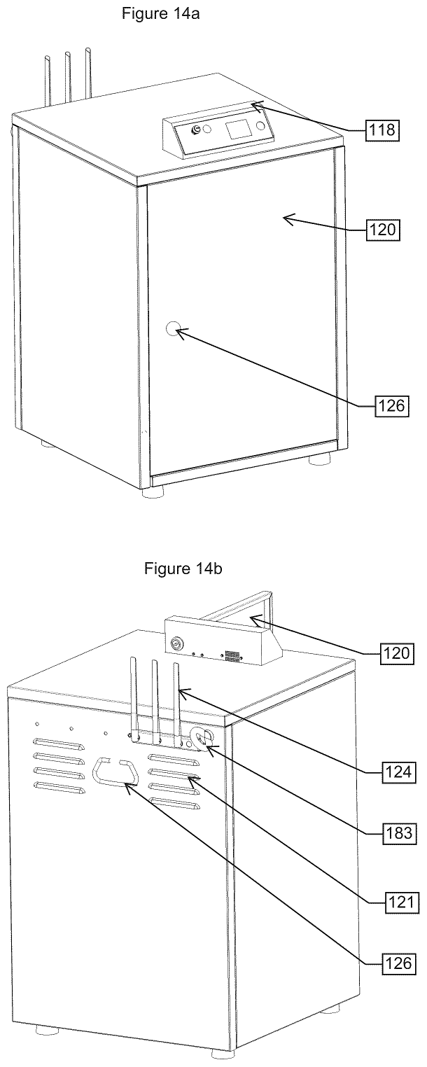

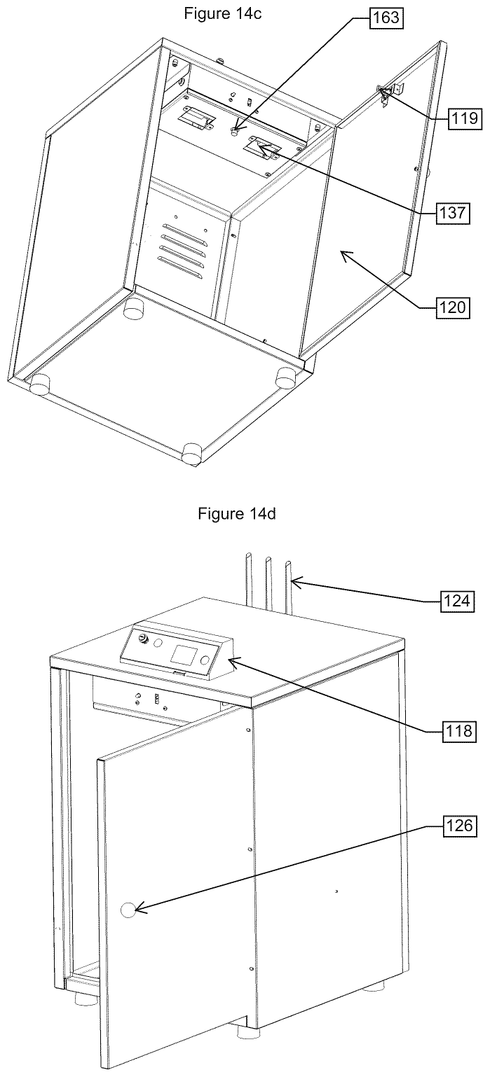

Parcel Receptacles: The various embodiments of this invention involve utilization of a tamper-proof, weather-resistant, flexible or rigid or semi-rigid parcel receptacle. Parcel receptacle can have access from the top portion as shown FIG. 8a or FIG. 11b, or it can have access from the front side as shown in FIG. 14a. The parcel receptacle can be either a fixed size or a variable size to fulfill one's need to accommodate various scenarios associated with delivery, return or exchange of parcels. In addition, the parcel receptacles shall have one or more of locking and/or unlocking mechanisms described elsewhere in this application to identify authorized individuals and to facilitate access for delivery of parcels or return or exchange of parcel from parcel receptacles. Also, in many practical implementations, multiple parcel receptacles may be necessary to receive multiple parcels and deliveries in a given day, and as such, every reference to a single parcel receptacle should automatically be interpreted as a reference to one or more parcel receptacles without requiring to be mentioned specifically as such. Additionally, to receive groceries and other goods that are perishable in nature, and that require cool temperature, parcel receptacles can be configured to be refrigerated by dry ice or other appropriate means in order to fulfill the intended use of the application to maintain certain temperature. Additionally, a password and code generating mechanism can be configured using one or more computer or electronic means to access the parcel receptacle so that authorized individuals can deliver, retrieve or exchange one or more packages into a parcel receptacle.

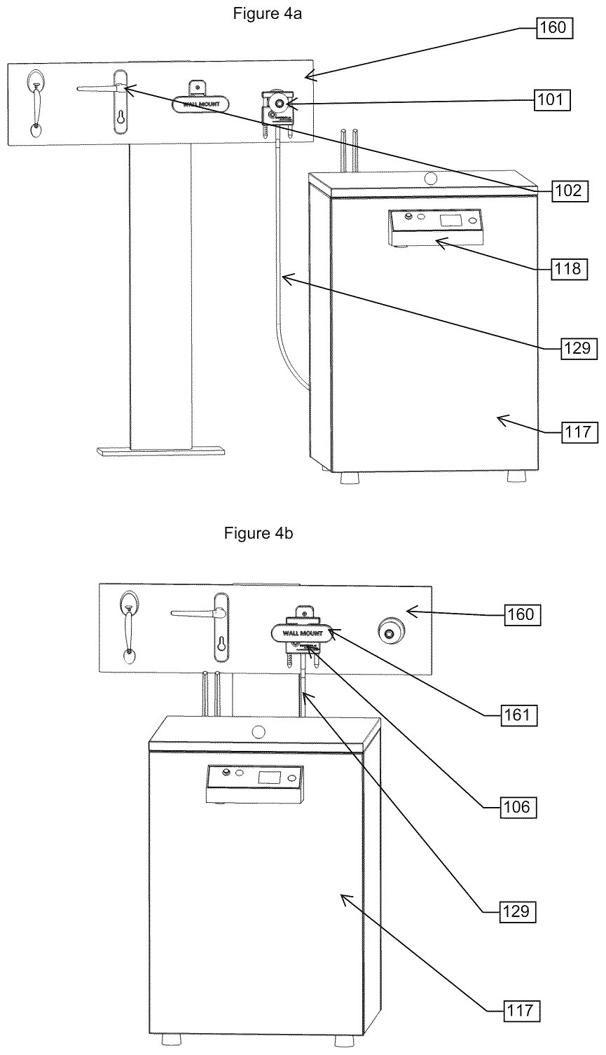

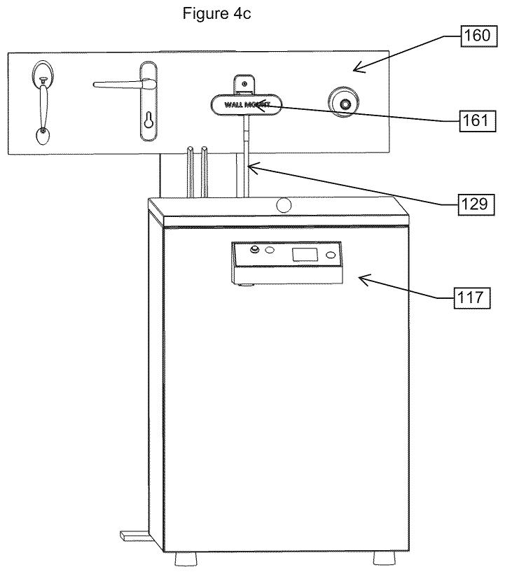

Cable, Chain or Rope References: The word cable or chain or rope are referenced a number of times in this application. It is important to note that these words have meanings that are similar and inter-changeable in the context of this application, and these words are not meant to be used in any restrictive manner intentionally or unintentionally. In addition, reference of cable, chain or rope, in general, infer that they are flexible in nature. However, some or all portions of these cable, chain or rope in some of our embodiments, may need to be configured to be rigid so as to fulfill the purpose of its application in specific designs. So, it is important to note that references to cable, chain or rope are not only meant to be interchangeable in nature, but could also mean to refer to a rigid, semi-rigid or flexible material in nature, and no restrictive meaning is intended to be inferred or derived from their usage or reference. In addition, the reference to a cable to wrap around a doorknob could also mean usage of a solid, contoured piece of a material to hold a security apparatus to a doorknob securely and can actually mean to refer to a solid piece rather than a cable assembly. So, in essence, the word cable, chain or rope or their respective assemblies such as cable assemblies mean to infer a way of connection between one component and another component in the embodiments in the context of this invention and shall not be inferred to be restrictive in their meanings intentionally or unintentionally. All these cable/rope/chain comments are applicable even in the context of creating a connection mechanism to connect two different parts or components together securely to prevent separation of one from the other and alerting by audible alarm or other means in case of theft or other such unauthorized tampering or separation. An example cable is shown as part (129) in FIG. 4a.

Locking and Unlocking Mechanism: This is a very essential and important feature of this invention. There are a few places where locking mechanisms are utilized in this invention. First, close to the doorknob or door handle to which a security apparatus can be connected. Second, on the parcel receptacle to secure the parcel inside the parcel receptacle to ensure only authorized individuals have access to it. The locking and unlocking mechanism can be a) simple, conventional physical type involving combination locks or electronic or other locks that utilize latest advancement in technologies such as b) IOT-operated wi-fi locks, c) Bluetooth-based locks d) mobile phone-based applications e) Fingerprint based activation, or f) any wireless-based communication such as Near Field Communications (NFCs) protocols and other Wi-Fi and wireless technologies. In addition, the locking and unlocking mechanisms could involve electronically or electronically activated solutions such as a solenoid valve driven, or other electrically or electronically and wi-fi activated locking and unlocking mechanisms. So, it is important to note that any reference to a locking or unlocking mechanism anywhere in this application automatically means the use of one or more of any of these solutions without requiring any specific mention or reference them to avoid repetition.

Intrusion and Audible Alarm: The various embodiments can have an intrusion alarm system if the security attachment and/or parcel receptacle and/or lock(s) are attempted to be tampered. The sound alarm will last for a preset time interval so as to not drain a battery or any source of energy and at the same time deter unauthorized person from continuing their intrusion or tampering. This can be an embodiment where additional security is desired in certain locations or applications. An additional embodiment is also to have a feature where the decibel level of the sound and time duration of the alarm can be adjusted. A typical example is the audible alarm set up, but it can be present anywhere in or around parcel receptacle or the various enclosures (146) attached to it.

Motion Sensor, Camera and Video: To enhance usefulness of our invention, a camera system can be configured in the security attachment and/or parcel receptacle to capture activities associated with various scenarios and events that occur while the system functions to fulfill its intended use. The camera system can be configured to capture pictures or videos of activities in and around its place of use and operation to enable monitoring and/or controlling and/or recording of activities. The camera system can be configured to be equipped with a motion sensor (can be either integrated into the camera itself or can be an additional and separate motion Sensor to detect motion) that is expected to trigger capturing of activities when there is any motion or tampering of the system, or when a record-worthy event occurs near the parcel receptacle. There are many record-worthy scenarios during which the camera and video recording can be configured to be used and not all scenarios can be adequately covered or explained in this application, but here are some common examples and scenarios during which the camera can capture activities. For example, the camera system can capture pictures or videos when a delivery personnel approach to deliver a parcel. The camera can capture when a customer or recipient intends to return a parcel and when a carrier personnel approach to retrieve the parcel from the parcel receptacle. The camera can capture when there is any movement near the vicinity of the security apparatus when such movement is expected, or unexpected or suspicious. The camera could also capture when there is any unexpected jerk or tampering of any of the components of the system/apparatus. The pictures and videos can be configured to be either stored locally or on the cloud or transmitted or communicated wirelessly or streamed instantaneously depending on the scenario.

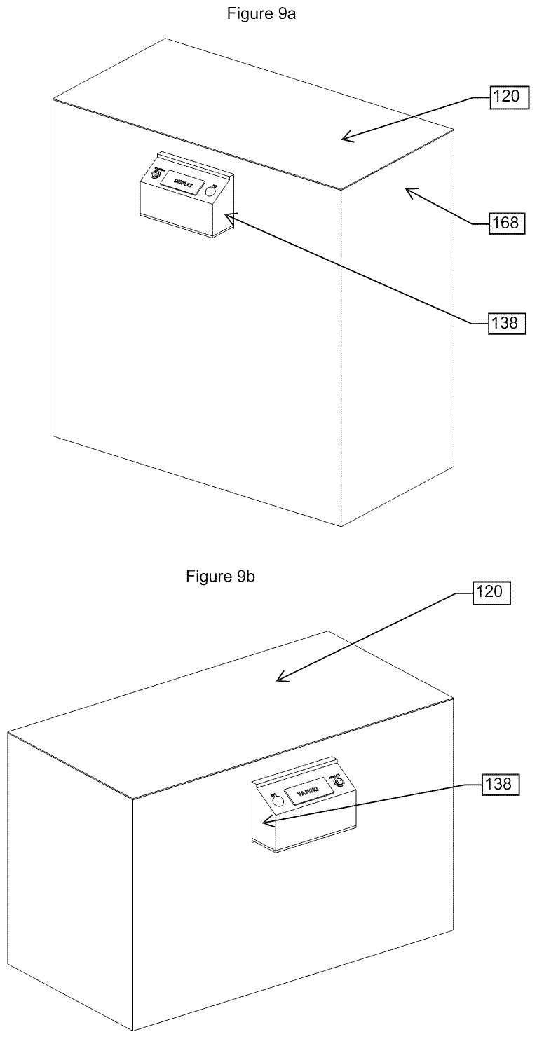

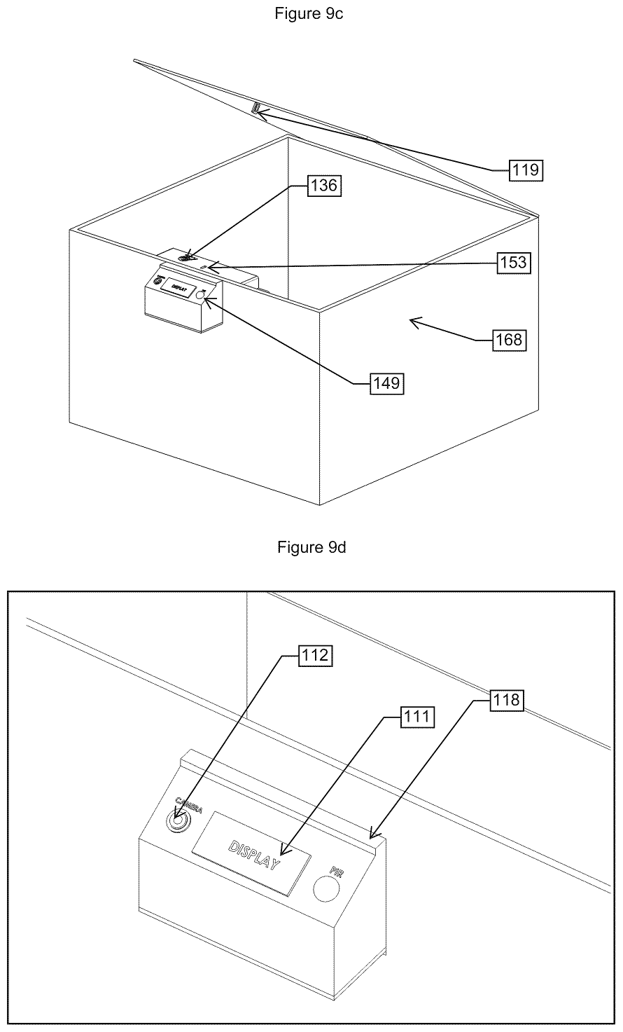

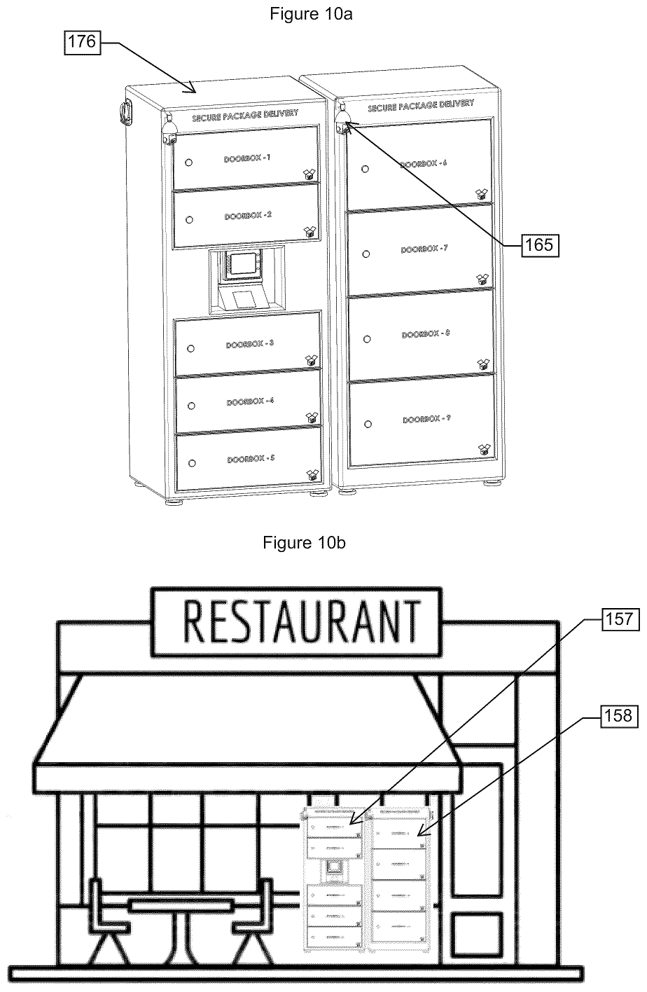

In addition, camera can be configured to be used like a scanner to trigger various actions. For example, such actions could include monitoring or controlling of the locking and unlocking mechanisms of the security apparatus and/or parcel receptacle. For example, when a carrier scans the tracking number or order number, the camera can be configured to enable such scan, and if such parcel is expected or authenticated, allow unlocking of the parcel receptacle to enable placement of the parcel inside the parcel receptacle. In addition, integration of quick response (QR) codes or Universal Product Codes (UPCs), or other forms of barcodes with the camera scanning can be configured to monitor and control the locking and unlocking of the parcel receptacles. In appropriate cases, upon authentication, such actions can be configured to be integrated with the digital displays to communicate messages, alerts and codes. This camera is shown as part (112) in FIG. 9d as an example. The camera can also be used to take, store or transmit still pictures of the contents inside the parcel receptacle at any time or when needed or on-demand.

Notifications, Communications and Alerts: The various embodiments can be configured to utilize one or more of technologies to offer features to notify communicate or alert the owner or recipient of the system/apparatus during appropriate events. For example, when a parcel is delivered, it can communicate the status to the recipient that a parcel has been delivered. The parcel delivery event can be configured in one of many ways. For example, when there is a movement in the vicinity of the assembly followed by an action where the parcel receptacle is locked, it can be configured to accept those activities and associate them to an event of parcel receipt. Similarly. when there is a movement in the vicinity of the unit, followed by an unlocking of the parcel receptacle, it can be configured to associate and conclude that a parcel has been collected by carrier personnel to return a parcel by the recipient. Similarly, where there is any movement in the vicinity of the assembly and when there is any unexpected tampering, it can be configured to notify the recipient to alert such uncommon activities. By integrating the parts of the system with appropriate computer program and appropriate algorithms, detection and transmission of any appropriate notifications or alerts via email, phone, wi-fi or instant messages can be configured.

Device Software and Mobile-Phone Applications: The various embodiments can be configured to utilize integration of appropriate mobile phone-based applications, commonly referred to as mobile phone app, or software installed on the device, to communicate various scenarios, events, statuses, notifications, alerts, pictures, videos, etc. to authorized individuals, so as to allow interaction with the security apparatus and parcel receptacle in a meaningful way. For example, locking and unlocking of the parcel receptacle and/or the security apparatus can be configured to be controlled wirelessly in many ways including control from a mobile-app or from an internet cloud-based software program remotely, or can be configured to automatically lock and unlock based on package delivery status.

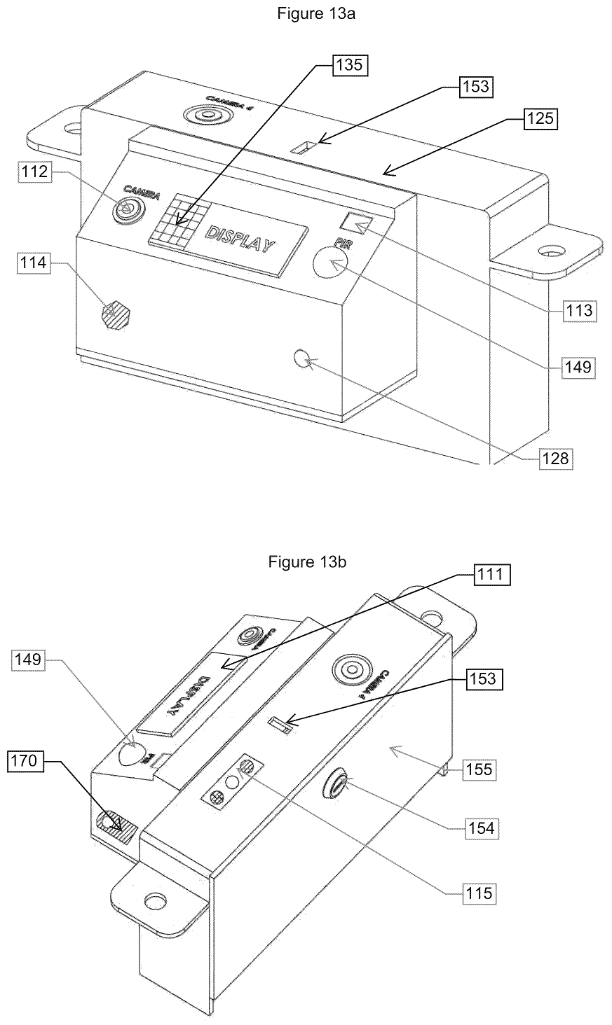

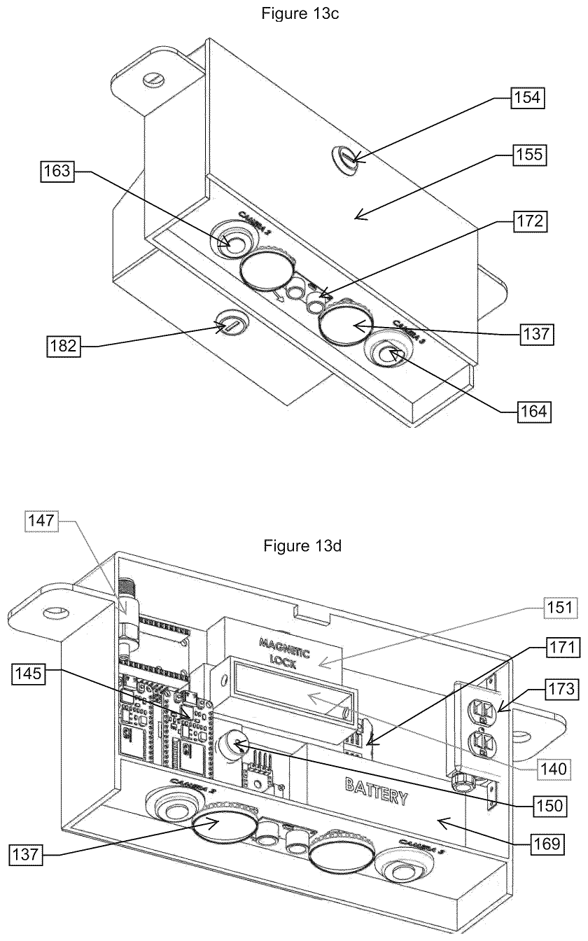

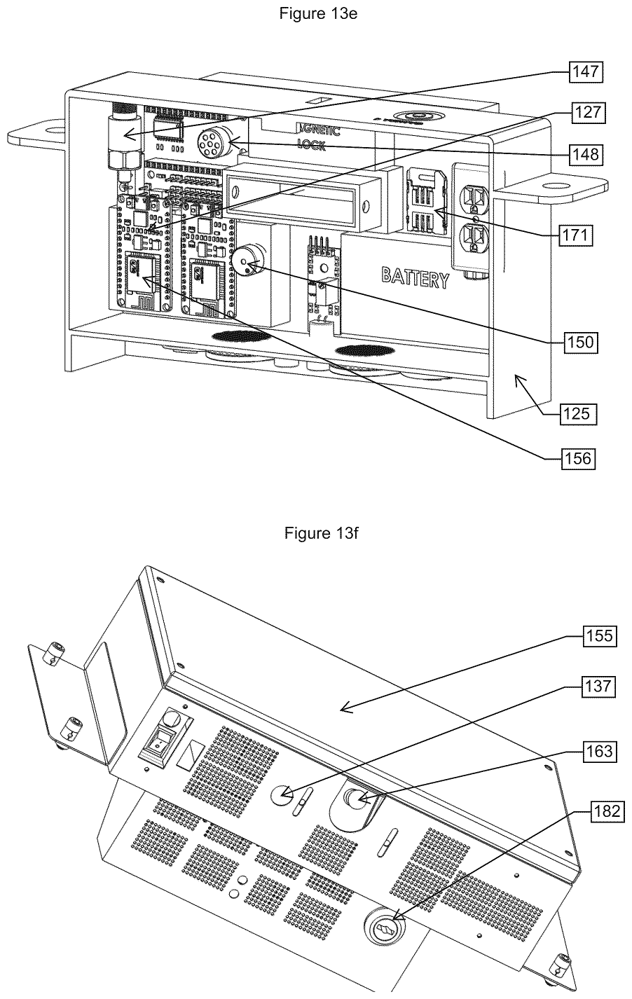

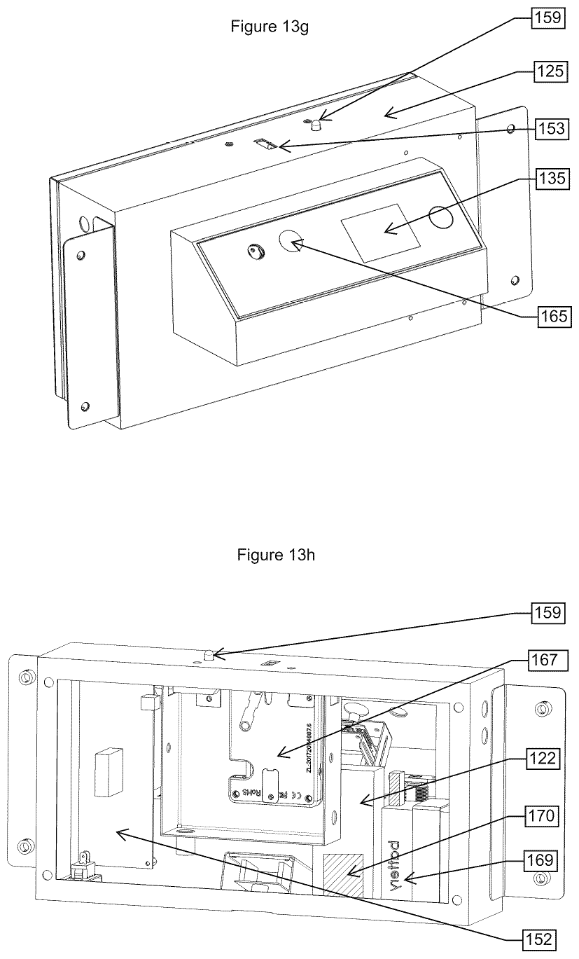

Electronics and Computer Hardware: Any technological solution comprises of electrical or electronic parts and one or more computer hardware. Our security apparatus and/or our parcel receptacle will house the necessary electrical and electronic parts and one or more of the necessary computer hardware including the necessary PCBs (printed circuit boards) to support and fulfill the features and functionalities described in this invention. For pictorial purposes, some of these were displayed in multiple figures in my earlier U.S. Pat. No. 10,083,561, and it is shown for conceptual reasons only and their actual location may be anywhere. This electronic circuit PCB Board is shown as (145) in FIG. 13d, and it would be housed inside a weather-proof enclosure and may not be visible from outside. Depending on a specific embodiment, this part can be housed anywhere inside, outside or near the parcel receptacle (117) to suit a particular application.

Microcontrollers such as Renesas DA16200 or family of other amazing products from Renesas, or Arduino or Arduino-like or Arduino equivalent have many attractive features that can be utilized in our application. Also, hardware like Raspberry pi or its equivalent also offers significant benefits for our application. Wi-fi modules, LED lights, 2-way audio, voice guidance, and many other peripherals are readily available and present for one or more of these pieces of hardware, and not all of them are specially listed in our application or explained in detail. For example, gyro meter, accelerometer and magnetometer all provide excellent features that can be utilized to sense movement, orientation or distance in our application, and they may or may not been highlighted separately. Similarly, an ultrasonic sensor (172) or AI-powered software can be utilized for our package detection algorithm singularly or can be integrated with observations from a motion sensor or an inside camera image, or other peripherals or software to be configured and deployed in the system. These details are not specifically elaborated as there are many configurations possible and all possible combinations of these hardware are included and covered in this application.

Energy Sources and Supply: To power the electrical and/or electronic or computer hardware, the components need power or energy. Energy can be provided from a regular power outlet (173) or from a battery (169) or a rechargeable battery or from a solar panel (144) or by other means. The batteries can be housed anywhere inside, inside or near the parcel receptacle depending on its size and utilization.

Data Storage & Transmission: Data is powerful and in fact very crucial these days. When camera and/or video is activated either due to motion around the device, or due to a configured event such as parcel receptacle opening or closure, or tampering, etc., data is generated. To store data, a storage device such as an SD card, a hard drive or a flash drive may be used and can be housed inside or near the parcel receptacle. In addition, through a mobile app or through software or programs installed on the device, and with wired or wireless connectivity via wi-fi network, or via carrier-operated networks via SIM cards, data can be stored or transmitted remotely or streamed instantaneously to one or more external devices including to an internet cloud platform. Working with other electronic or computer hardware that is present in the system, such data can be transmitted to appropriate authenticated devices via commonly available data transmission protocols. In addition, when data is not necessary to be transmitted instantaneously at the time of data collection, a mechanism can be configured to be provided to retrieve the data by a wired or wireless mechanism on an as needed basis. In addition, all data associated with the device can be configured to be stored, transferred or transmitted to external sources including an internet cloud platform.

Display Panel: As shown in many figures, part number (111) represents a digital display mechanism that can be integrated into many embodiments, and can be configured to communicate several messages, codes, alerts, statuses, etc. in an interactive fashion to authorized individuals. From those displays and codes, locking and unlocking of locking assemblies and/or parcel receptacles can be configured and selective access to authenticated individuals can be provided.

Illumination Lights: As shown in many figures, part number (137) represents an illumination light. One or more of these can be present both inside and outside the parcel receptacle. These illumination lights can be configured based on selected events or triggered events at or near parcel receptacle.

Display Signals: As shown in many figures, part number (115) represents a few display signals of varying colors. This can be configured to communicate various statuses such as battery levels, or armed/unarmed status of security apparatus and/or parcel receptacles.

Internet of Things (IOT), Wireless Technologies and Wireless Transmission: In modern days, wireless technologies offer a great level of convenience and there are numerous types of wireless communications. The data transmission, locking and unlocking mechanisms can all be operated either via physical means, or via wireless means. Wireless signals may fall into one or more categories such as IOT, RFID, Bluetooth, SIM card-based Wi-Fi networks, NFCs, other types of Wi-Fi networks and technologies. All these technologies are configured to be implemented with my invention to fulfill its intended use effectively even if these are not mentioned specifically each time for sake of brevity.

Fingerprint and Biometric Module: A fingerprint or biometric module can be integrated in the doorknob security apparatus and/or the parcel receptacle. This feature can be configured to identify authorized individuals, and upon such authentication, these modules can be configured to activate privileges of operation and access to security apparatus and/or parcel receptacle to those authenticated individuals. It is shown as part (113) in many figures.

GPS Module: A global positioning system (GPS) module can be placed either in the doorknob security apparatus or inside, outside or near the parcel receptacle. This feature can be configured for use based on need and/or a specific application. By this GPS feature, one will be able to identify the current location of the parcel receptacle at any given point. For example, this feature exists in most of the smart phones these days to identify and locate a phone, and this feature can be integrated with the security apparatus and/or the parcel receptacle. It is referred to as part (127) and can be securely placed anywhere inside, outside or near the parcel receptacle.

External Enclosure: The enclosure can appear curvy as shown in part number 118 as in FIG. 9d, or in different shapes as shown as part number 146 in FIG. 18a. These two-part numbers 118 and 146 are essentially the same in utility, and it can appear in any other shape, size or form as well. In most embodiments, a keypad (135) is likely to be provided as one of the means to authenticate access to the parcel receptacle at or near this external enclosure. And this keypad can be mounted anywhere outside of the parcel receptacle. The location can be in the front as shown in FIG. 13a, or on top as shown in FIG. 13g, or it can be mounted from behind using mounting mechanism on part number 134 on the back side. Each of these embodiments and placements offers certain advantages and all are covered in this invention.

Cloud Platform Integration: Technology, software and storage are important elements that are essential for the success of my invention. Internet cloud provides an amazing platform as all three of these are abundantly present in a typical cloud platform. So, wherever possible and appropriate, the cloud platform can be tightly integrated with my system in every aspect of my invention. Specifically, the cloud platform can be configured to connect to the system through a variety of technological means discussed elsewhere in this document and can provide numerous benefits associated with data collection and data dissemination to authenticated users real-time instantaneously or on an as-needed basis. Among other options, wired or wireless internet connectivity to the system is expected to enable optimum and efficient use of cloud platform and implementation of many described features.

Integration with Online Retailers, Pharmacies, Other Stores and Freight Companies: One of the main purposes of this invention is to facilitate secure deliveries by partnering with pharmaceutical companies involved in delivering medicines to customers, and online retailers, security camera companies such as Ring, Nest, etc., and mobile app based delivery companies such as instakart and ubereats, etc. Doorbox enables deliveries to occur securely and efficiently. So, integration of the locking and unlocking mechanisms of the parcel receptacle with both online retailers and freight carriers is an important feature. Integration of features such as order number or tracking number and appropriate barcodes or QR codes on the parcels or to authentic parcel carriers can all be appropriately integrated with locking and unlocking mechanisms of the parcel receptacle. In addition, these features can be coordinated with online retailers, pharmacies, restaurants, and other stores and freight carriers to come up with a mechanism to authenticate access to delivery personnel or others and to provide appropriate access to lock or unlock the parcel receptacles. Such coordination can happen electronically including via emails from the online retailer or from the freight carrier and integration of those communications to trigger one or more actions on the security apparatus or parcel receptacle.

Integration with Other Apps and Other Software from Other Companies: One of the main purposes of this invention is to facilitate security and convenience of online shopping, and secure exchange. Our package receptacle and system can be configured to work with other companies and software to provide more value to our customers. For example, applications such as Nextdoor, Ring's neighborhood app, and other apps from security camera companies such as ADT. Google Nest, etc. are all feasible to be technologically integrated with our system and are included and covered in our invention. Such integration provides more security to neighborhoods and convenience to people.

Redundant Display of Parts in Figures for a Reason: It is very important to state that many of the figures show not only basic (physical) parts, but also include, sometimes redundantly, parts that are either substitute to those ‘physical’ parts or parts that can be optionally used as additional parts to augment the features and functionalities of our invention. For example, locking and unlocking of security attachment (106) and/or parcel receptacle (117) can be solely achieved by a physical lock and key mechanism. However, as an option and/or as a feature, RFID (114) and fingerprint (113), are shown additionally and redundantly in many figures, to explain that any one or more of these mechanisms/technologies can be used to fulfill the locking and unlocking, although not all of them (i.e., 113 and 114) need to be present in each embodiment to function as intended. Similarly, there are other many other parts such as 112, 113, 114,115, 111 that are shown in both security attachment and parcel receptacle and the part could be in one or both depending on a particular embodiment.

Usage in or near Office Premises or Other Buildings: Employees often tend to order their personal items and have them delivered in their offices. This has caused increased workload to mailroom staffs, and increased inconveniences to office staff and growing number of organizations have informed employees not to order their personal items delivered to their office anymore. Our DoorBox can be offered by organizations that want to offer their employees the convenience of receiving their goods securely near their offices without burdening their mail-room employees. If multiple parcel receptacles are deployed in office campuses, employees can use the respective parcel receptacle number and make use of them for temporary usage. Via GPS and other technologies present in our parcel receptacles, widespread adoption and usage is possible.

Usage For Food and Other Deliveries: There are occasions wherein people are living in high-rise buildings, or in situations wherein they are unable to meet the delivery person directly and collect their food or other items they have ordered or purchased. In those cases, they just want the delivery person to drop their food or items securely into a parcel receptacle like DoorBox and leave. In this case one can use our parcel receptacle to drop the food so that owner of the food can be notified appropriately, and they can come and collect at a later point when it is convenient for him/her.

Usage for the Travelling People: People who are travelling for business purposes or for personal reasons sometimes must buy something from online urgently. They may be staying in an Airbnb or in hotels and they are not allowed, or they choose to not receive a delivery in the respective addresses. In this case they can choose the nearest parcel receptacle to their location and make the purchase so that they can buy a product without any difficulties wherever in the world.

Customization Options for the Secure AI-Powered DoorBox: The secure AI-powered DoorBox offers extensive customization options to meet diverse user needs and preferences, enhancing its visual appeal while maintaining core security features. Users can personalize the front panel with designs such as animal-themed images of pets, floral-themed images like bouquets of roses, or textual designs with custom fonts and colors. The DoorBox is available in multiple sizes to accommodate various delivery volumes, from compact boxes for small parcels to larger units for bulkier items. Color customization options include a standard palette and custom color requests, allowing the box to blend seamlessly with different environments. Additionally, the DoorBox is offered in various materials, including robust metals for high-security needs, weather-resistant composites for outdoor installations, and decorative finishes for a refined look. These customization options ensure the DoorBox enhances the aesthetic appeal of its surroundings while providing versatility and durability.

Door Box with Integrated Postal Slot for Enhanced Mail Security and Convenience: The Door Box is a secure and versatile parcel receptacle designed to receive, return, and exchange parcels efficiently. In addition to its existing components, a postal mail slot can be integrated into the Door Box to facilitate the easy dropping of small envelopes and mail inside. This postal slot can be positioned on any side of the box, ensuring convenient access to drop mails and envelopes inside while maintaining the security of the contents. For larger parcels, one must open the lid only, and it may be located on the top or on the front depending on the embodiment. The postal mail slot is equipped with a protective flap that prevents rainwater entry, tampering and unauthorized access.

In the drawings, descriptions and specifications discussed above, a few typical embodiments of the invention are disclosed. Although specific terms and elements are used in description, they are used in a descriptive sense only, and not for the purpose of limitation. It is apparent, however, that various modifications and changes can be made in the specifications, designs, elements to create a greater number of embodiments without departing from the spirit and scope of the invention. The method, device, system, and apparatus are a utility product that can have several embodiments and each embodiment has one or more features to securely receive, return and exchange a parcel. The essential advantages of the various embodiments of the apparatus, method and mechanism are many, and should not be limited to the examples illustrated in this specification only.

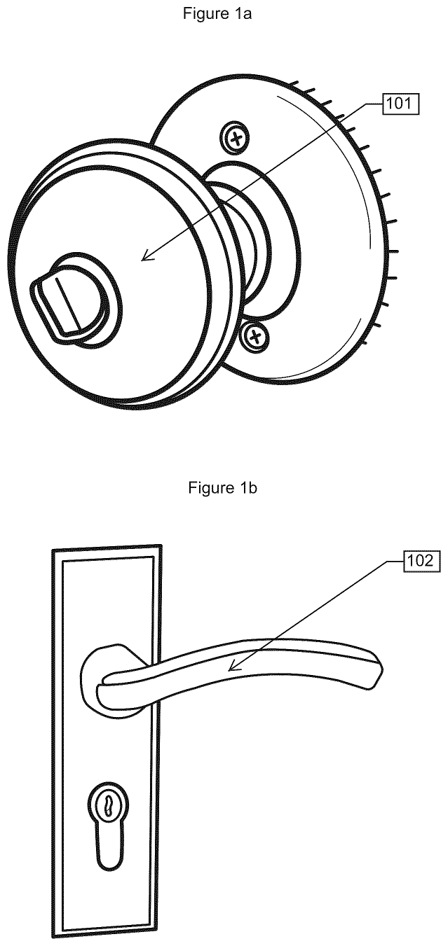

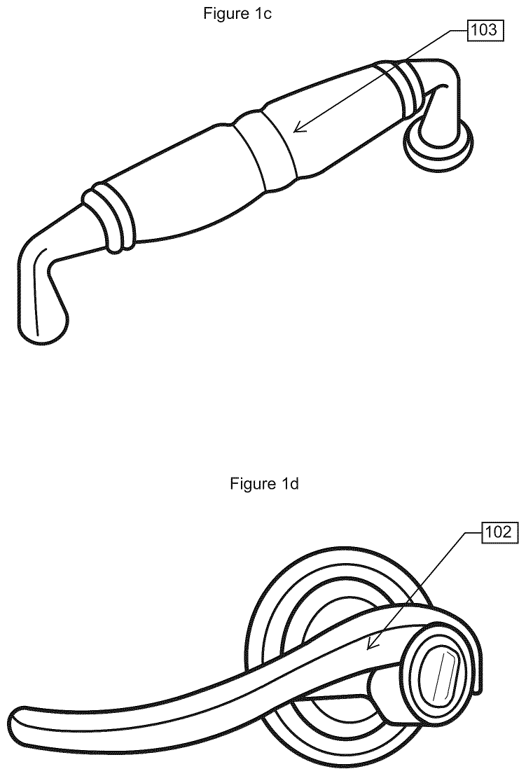

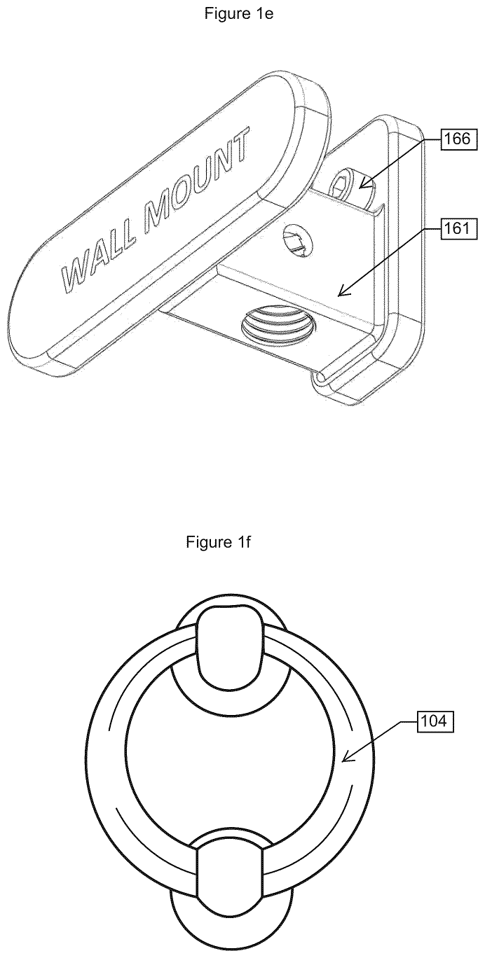

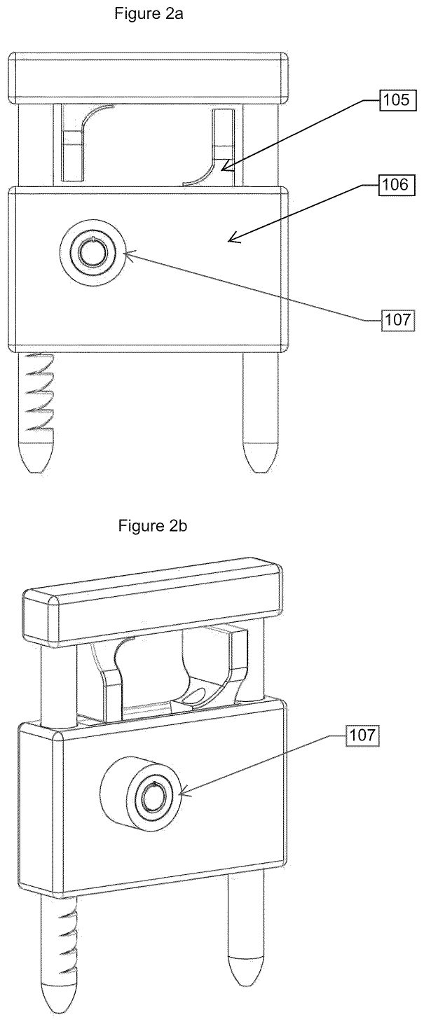

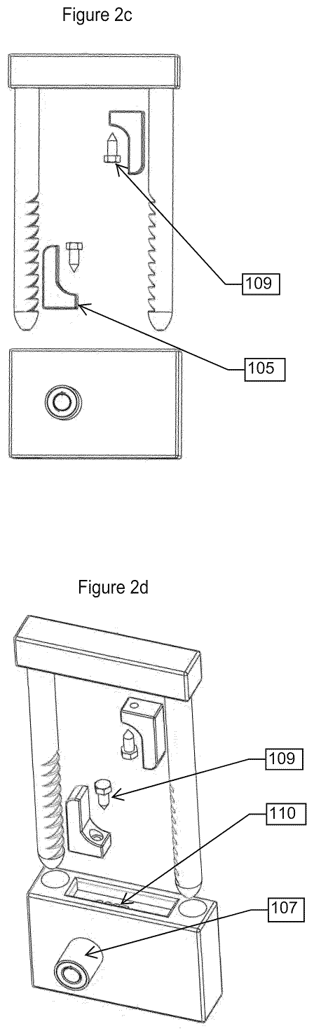

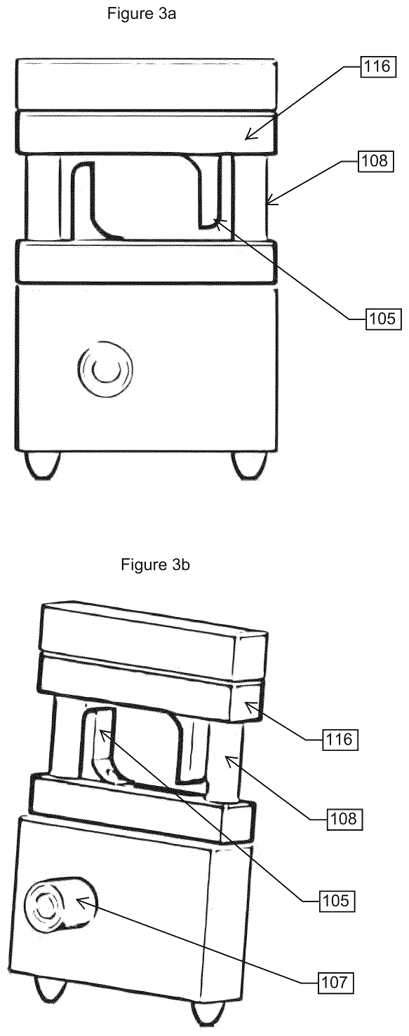

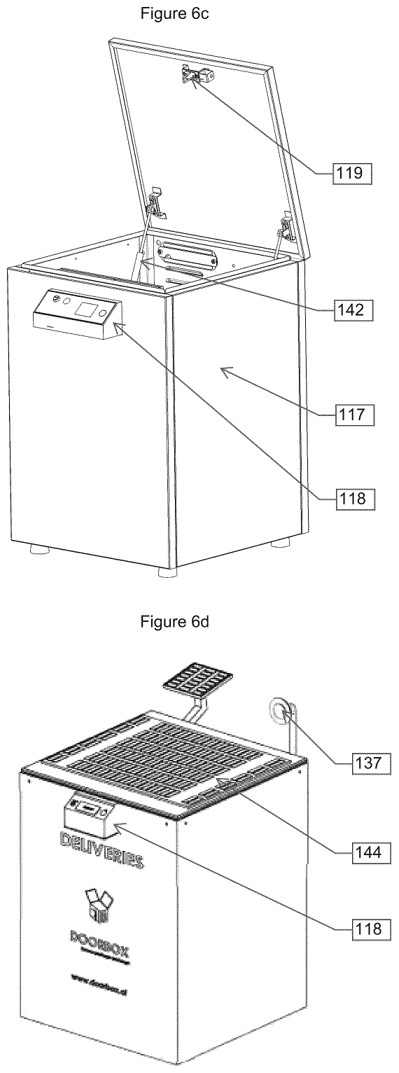

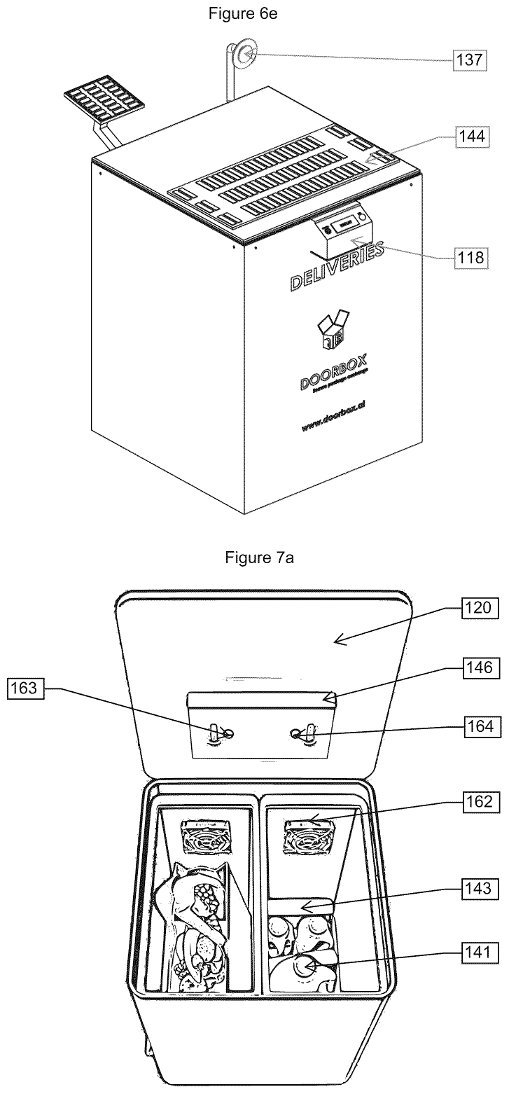

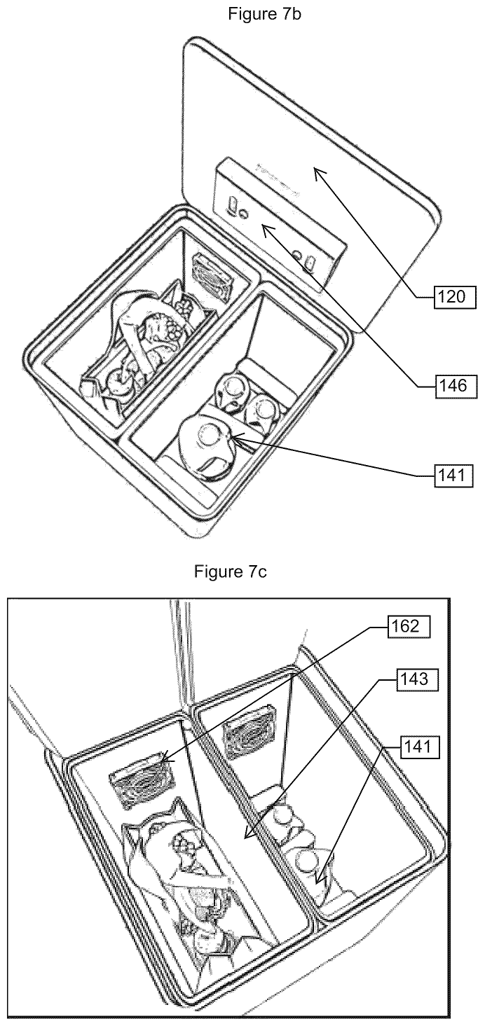

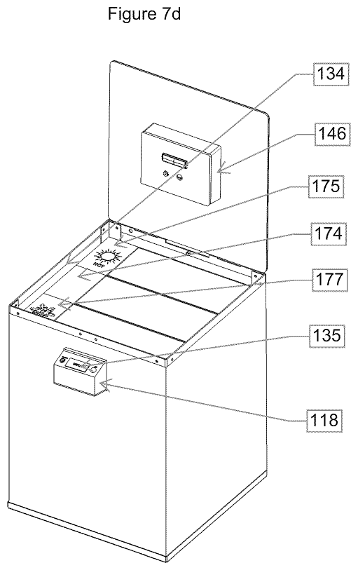

TABLE 1
Part number and description
The following table (Table 1) provides a list of referenced parts in many figures
and contains a brief description and illustration of the part where appropriate.

| Part | |
|---|---|
| Number | Description |
| 101 | A typical circular doorknob. |
| 102 | A typical straight-shaped doorknob. |
| 103 | A typical door handle. |
| 104 | Examples of Doorknockers, and this can be of many types. |
| 105 | Locking cartridges. Varies in geometrics and dimensions depending on |
| | doorknob types and other stationary fixtures. |
| 106 | Security apparatus or security attachment or locking assembly. This is the part |
| | that can be used to tether a parcel receptable physically to a stationary object to |
| | secure via a tamper-proof cable or by physical means. This part can be avoided |
| | when tethering of parcel receptacle is accomplished via a wireless means. |
| 107 | The key barrel or tubular lock of the lock-key mechanism where the security |
| | apparatus key is used to lock and unlock. |
| 108 | Shackle. |
| 109 | Screw to securely hold cartridges to top and bottom bases. |
| 110 | Threads to secure cartridges (109) into top and bottom base. |
| 111 | Display panel (Can be LCD, LED, or any type) to communicate lock or unlock |
| | codes, or an interface to communicate any kind of messages such as alerts, |
| | notifications, etc. This can be present anywhere near the parcel receptable. |
| 112 | Camera or video recording device or a scanner. It can be mounted on the security |
| | apparatus and/or placed on the parcel receptacle in some embodiments, or |
| | anywhere along the interconnecting chain or cable in some other embodiments. |
| | A camera or scanner can be used to scan barcodes or UPC codes or QR codes |
| | or any other codes and act upon authentication as desired. This camera, either |
| | individually or along with provided software can identify various objects such |
| | as a delivery person, their dress color, dress patterns, car, cat, dog, vehicle, |
| | delivery vehicle, etc. and perform a subsequent desired action as needed. This |
| | can be mounted anywhere in the system as shown in Figures. |
| 113 | Fingerprint or biometric reader. This can be used to authenticate authorized |
| | individuals. Can be mounted on the parcel receptacle, or anywhere in the system |
| | shown in FIG. 13a. |
| 114 | Wireless sensor. This is mainly shown for pictorial representation only. This |
| | could be a wi-fi module that connects to the internet, or an RFID sensor or other |
| | wireless technology-based solution such as a Bluetooth or mobile-based |
| | software application. Depending on the exact technology utilized in a particular |
| | embodiment, this could be placed inside or outside of Parcel receptacle or could |
| | be integrated into the PCB board and other internal mechanisms that are not |
| | explicitly displayed outside. This can either replace a doorknob lock or can be |
| | an optional additional feature of doorknob security apparatus as alternate |
| | embodiments. Wireless mechanisms can be of many types including RFID, |
| | Bluetooth, Wi-Fi, Mobile application-based technologies, NFCs, among other |
| | wireless applications. This can be mounted anywhere in the system shown in |
| | FIG. 1a, 1b or 1c, including on the parcel receptacle or can be mounted on the |
| | interconnecting cables, etc. |
| 115 | This visual display of signals is shown for pictorial purposes only. This can be |
| | an indicator for all kinds of statuses such as armed, disarmed, battery levels. A |
| | flashing status could also be used for timer-based and triggered mechanism and |
| | could indicate when a wireless-activating device is brought near to acknowledge |
| | receipt of a wireless signal and display that control programs inside are working |
| | at a given time to perform an activity. This can be mounted anywhere in the |
| | system shown in FIG. 4a, 4b or 4c, including on the parcel receptacle or can |
| | be mounted on the interconnecting cables, etc. |
| 116 | Extra-fitting for a locking assembly that can be made of Engineering plastics or |
| | polymers or other similar materials that can be adapted for cartridges of various |
| | dimensions and geometries. |
| 117 | Parcel receptacle (or parcel bag or parcel box or parcel container). Can be of |
| | many types and many sizes and with many additional options and variations. |
| 118 | IOT Electronics Enclosure assembly to hold relevant parts together. This can |
| | be mounted in the front or on the top lid. There can be one or more individual |
| | of these enclosures each fulfilling one or more of its intended functions. This |
| | can be of any shape or size, and can be made of metal, plastic or any other if it |
| | fulfills the needed structural strength and aesthetic appeal. Essentially, this is |
| | same as part number 146 although this enclosure 118 is used in shapes that |
| | appear curvy in its appearance in these figures. For all practical purposes, part |
| | 118 and part 146 are interchangeable. |
| 119 | A locking latch. This can be of female-type with a ring or an L-shape plate, or |
| | just a flat plate for a locking lever to secure the top lid and to prevent it from |
| | opening. |
| 120 | The parcel receptacle should have either a top or front lid serving as a door. |
| 121 | Louvers are slats or blades, adjustable or fixed, used to control airflow and light |
| | in windows, doors, and ventilation systems. They provide privacy and weather |
| | protection while allowing optimal ventilation and light penetration |
| 122 | Enclosure for alarm unit. This could be placed anywhere on the inside or outside |
| | of the parcel receptacle. If the alarm is integrated inside other enclosures, this |
| | may not be present. This can also be configured to be a buzzer and it can be |
| | placed inside enclosure 146 instead of having a separate alarm enclosure for |
| | alarms. |
| 123 | A continuity cable/wire that signals when it is tampered with or cut by any |
| | unauthorized individuals or actions. The may be present singularly or along with |
| | 123 depending on a specific embodiment. |
| 124 | A physical antenna is a device used for transmitting and receiving |
| | electromagnetic waves, converting electrical signals into radio waves and vice |
| | versa. It is crucial for wireless communication, enabling signal transmission for |
| | radio, mobile phones, and other wireless devices |
| 125 | Inner case part 1 either it could be metal or plastic any kind of material |
| 126 | Either it could be a handle or holder or knob to lift or move parcel receptacle. |
| 127 | GPS module. Comprises of all necessary parts to transmit necessary signals to |
| | reveal the present location of a parcel receptacle to authenticated individuals. |
| | This GPS module is small, and it can be housed anywhere inside a security |
| | apparatus and/or parcel receptacle. |
| 128 | 2-Way Audio Device, i.e., a microphone and a speaker. There can be 2 |
| | independent devices, or one integrated 2-way audio device. This could allow a |
| | parcel recipient to listen and talk to a delivery person or anyone in front of the |
| | camera or parcel receptacle. This can be integrated with one of the electronic |
| | chips or can be standalone hardware. |
| 129 | Cut-resistance cable or rope or chain. Some or all portion of this can be solid |
| | and rigid to provide strength and other properties needed in appropriate |
| | configurations |
| 130 | A package delivery person that carrying the package to deliver into the parcel |
| | receptacle |
| 131 | A package delivery truck, van or a car from different companies. |
| 132 | A package that is intended to be delivered inside the parcel receptacle securely. |
| 133 | The bottom side of a package receptacle. It can be of plywood, metals, or plastics |
| | or any other kind. |
| 134 | A top frame. This could be metal, or plastic or any kind of material that provides |
| | structural strength to the parcel receptacle and provides boundary to the top |
| | frame or supports the lid and holds several parts on it. |
| 135 | A keypad interface that allows entry of codes and that provides access into |
| | parcel receptacle upon authentication. |
| 136 | Inside-facing Camera that shows whether there are any packages inside |
| | DoorBox. |
| 137 | Illumination or light source. One or more may be present both inside and outside |
| | a parcel receptacle. |
| 138 | Outer case Part 1 either it could be metal or plastic any kind of material |
| 139 | A cushion that is easily compressible so that when heavier packages are placed |
| | on top, it would get compressed and go down, and when there are light weight |
| | packages are placed, those will remain at the top. This allows more depth of |
| | DoorBox wherein the customer don't have to bend too much when the package |
| | weight is very little or when packages are very small. |
| 140 | Inner case clamp metal or plastic any kind of material in any shape |
| 141 | Beverage or food. |
| 142 | The gas struts facilitate the opening and closing of the lid. Similarly, a |
| | mechanical spring, hydraulic dampers, counterbalance systems, and linear |
| | actuators can be used. |
| 143 | Ice pack or any kind of cooling pack. |
| 144 | A solar panel for providing power and is used as an energy source to recharge |
| | batteries and to facilitate operation of electronic devices. |
| 145 | An electronic board that contains all necessary additional hardware and parts |
| | inside to offer several advanced features and functionalities. These may include, |
| | but not limited to, wi-fi module, IOT-module, SD Card for storage, devices for |
| | software storage and operation, and various accessories for the PCB Board. |
| 146 | Essentially, this is same as part number 118 although this enclosure 146 is shown |
| | in shapes that appear less curvy and more rectangular in its appearance in some |
| | figures. For all practical purposes, part 118 and part 146 are interchangeable. |
| | This enclosure houses many technological parts and hardware parts inside and |
| | can be made up of one or more pieces that can be configured to be installed |
| | either separately or together. This can be present anywhere inside or outside or |
| | in both places of parcel receptacle. Also, this can be mounted in the front |
| | (FIG. 6c), or top (FIG. 14a) or mounted from behind (not shown). |
| 147 | The Advanced Vibration Sensor provides a highly sensitive, accurate, and real- |
| | time solution for detecting and monitoring vibrations across various |
| | applications. |
| 148 | A sound sensor. Detects unexpected tampering or unauthorized intrusion. |
| 149 | A motion detection system comprising one or more of the following: a passive |
| | infrared (PIR) sensor, a photoelectric sensor, a Lidar sensor, or other suitable |
| | motion detection technologies or sensors, configured to accurately detect motion |
| | or movements. |
| 150 | A buzzer or beeper is an audio signaling device, which may be mechanical, |
| | electromechanical, or piezoelectric. |
| 151 | A male locking rod that slides and locks the female ring on the lid thereby |
| | preventing unauthorized individuals from opening the parcel receptacle lid. |
| | This can be of many types including a solenoid valve or a sliding rod. This can |
| | be operated electronically and can be controlled by software programs as |
| | needed. |
| 152 | A printed circuit board (commonly known as a PCB). One or more may be |
| | present in the entire parcel receptacle to ease communication between different |
| | electrical and electronics hardware and software. A PCB board may also house |
| | several smaller electronic parts, each of which may not be mentioned here, to |
| | fulfill the intended functions. |
| 153 | Female lock pin for securing the hook closure. |
| 154 | A lock and key to secure the enclosure (146) from tampering. This enclosure |
| | contains many electrical and electronic hardware. |
| 155 | Door for the electronics enclosure (146). |
| 156 | Another electronic and electrical PCB. Can contain many different hardware on |
| | it to perform various operations. Can have one or more of ESP32, ESP32-CAM, |
| | Arduino, Arduino type and Arduino equivalent or raspberry pi or equivalent, |
| | and several hardware and peripherals. |
| 157 | Small Rack-type Parcel receptacles. Could open horizontally. May have springs |
| | inside that will automatically close these upon package retrieval. |
| 158 | Medium Size Rack-type Parcel receptacles. Fulfills certain applications and in |
| | certain use-case scenarios. |
| 159 | A limit switch is used to trigger the door mechanism, ensuring the door's status |
| | is accurately indicated as either open or closed. |
| 160 | This typically represents a door or any stationary plane that contains a stationary |
| | object to which a locking assembly (106) can be anchored. |
| 161 | Wall mount. Another example of stationary object. |
| 162 | Peltier module, compressor-based cooling, evaporative cooling systems, |
| | thermoelectric coolers, or refrigerators to actively regulate and maintain a lower |
| | temperature or a regulated temperature within certain range inside the parcel |
| | receptacle |
| 163 | Internal camera 1 or any other capturing device |
| 164 | Internal camera 2 or any other capturing device |
| 165 | External camera or any other capturing device |
| 166 | Screw for wall mounting. |
| 167 | An advanced lock system includes an electronic lock with an electric actuator |
| | and power supply, alongside a physical mechanical lock with a rotating |
| | cylindrical core, pin tumblers, and a durable metal casing or plastic any kind of |
| | material in any shape. |
| 168 | It could be either plastic box or metal any kind of material in any shape |
| 169 | Battery or any other energy source to power the electrical and electronic devices. |
| 170 | Audible alarm. When an audible alarm is triggered, loud sound is produced if |
| | there is any attempted tampering of the parcel receptacle or the security |
| | apparatus or any inter-connecting cables. In some embodiments, this may be |
| | integrated with the PCB with a buzzer also. This may be present inside, outside |
| | or anywhere near the parcel receptacle. |
| 171 | Sim card and sim card holder that provides internet access when other source of |
| | internet is not available in remote areas or away from a property with weak or |
| | no wi-fi signal or wi-fi network. |
| 172 | An ultrasonic sensor that measures the distance. This can be used to detect when |
| | packages are placed inside and when the distance to the bottom changes because |
| | of the presence of packages. |
| 173 | A connection source of electrical power. A plug is shown for clarity, but it can |
| | just be a female pin into which the power source can be connected to. This is |
| | like a hard-wire connection to power electronic and electrical devices. This is |
| | an example termination point, and it can be anywhere on the parcel receptacle. |
| 174 | Normal insulated container, insulated coolers, thermal bags, and vacuum flasks |
| | or any other insulator to maintain the object's temperature and withstand |
| | environmental changes. |
| 175 | Hot insulated container, insulated coolers, thermal bags, and vacuum flasks or |
| | any other insulator to keep the object hot and withstand temperature. |
| 176 | The master control DoorBox can be made from various materials such as plastic |
| | or metal and can come in any shape. |
| 177 | Cold insulated container, insulated coolers, thermal bags, and vacuum flasks or |
| | any other insulator to keep the object cool and withstand temperature. |
| 178 | Right side panel it could be either plastic box or metal any kind of material in |
| | any shape |
| 179 | Top side panel or top lid it could be either plastic box or metal any kind of |
| | material in any shape |
| 180 | Front side panel it could be either plastic box or metal any kind of material in |
| | any shape. |
| 181 | Left side panel it could be either plastic box or metal any kind of material in any |
| | shape. |
| 182 | The emergency unlocking procedure for electronic failure involves using a |
| | backup key. |
| 183 | The Anti-Theft Eye Bolt is a high-security fastener for the Door Box product. It |
| | features a reinforced eye and tamper-proof mechanism, preventing unauthorized |
| | removal. Coated for corrosion resistance and easy to install, it ensures durable |
| | protection for residential and commercial use to anchor DoorBox to prevent |
| | removal or theft from its installed location. |

### Implementation of Artificial Intelligence (AI), Internet of Things (IOT), Machine Learning (ML) and Software for Advanced Features and Beneficial Functionalities

In recent years, technological advancements have significantly enhanced the capability to perform complex human tasks with greater accuracy and affordability. Notably, there have been substantial advancements in facial and image recognition software, artificial intelligence (AI), machine learning (ML) technologies, and Internet of Things (IoT) based hardware and software. FIGS. 13a through 14d illustrate an innovative approach where multiple technologies work together to identify and authenticate individuals, providing robust authentication features without the need for continuous code entry into the parcel receptacle (117).

The system comprises a speaker and microphone (128), a camera (112 or 136), and a printed circuit board (PCB) designed to integrate various components, including a camera, motion sensor, display, SD cards, software, audio power amplifier, relays, locking rods or locking mechanisms, and a voice speaker. These components can be configured and integrated with the parcel receptacle (117). When a delivery person (130) approaches the parcel receptacle with a package (132), the system can guide them to use the parcel receptacle (117) properly, automatically open it, or lock it to secure the package with minimal effort.

The DoorBox is an advanced parcel receptacle designed to securely receive, return, and exchange parcels using cutting-edge technologies such as Artificial Intelligence (AI), Internet of Things (IoT), and Machine Learning (ML). This system ensures enhanced security, convenience, and automation for both delivery personnel and residents. The DoorBox integrates various electronic components and sensors to facilitate seamless parcel management operations.

### Automated Parcel Reception and Interaction

### Process:

Detection: The DoorBox utilizes AI-powered sensors to detect the approach of a delivery person or any movement near the parcel receptacle.
Interaction: Upon detection and if necessary, the integrated speaker system communicates with the delivery person. For example, it might say, “Hello, have you come to drop my packages?” Upon receiving confirmation, the system instructs, “Ok, I will open the DoorBox. Please place my packages inside.”
Execution: The DoorBox then automatically unlocks and opens the receptacle to allow the delivery person to place the package inside.
Completion: After the delivery person leaves, the AI and camera system confirm their departure and automatically lock the receptacle.

### Image and Situation Recognition for Resident Convenience

### Process:

Detection: The system's advanced camera, equipped with facial and image recognition and AI software, detects the presence of the resident.
Interaction: As the resident approaches, the system identifies them and the speaker system may greet them with a message such as, “You have a package.”
Execution: The recognition triggers the automatic unlocking of the parcel receptacle, allowing the resident to access their package.
Completion: After the package is retrieved, the system resets or secures the receptacle, preparing for the next interaction.

### Enhanced Security Measures

### Process:

Detection: During nighttime or suspicious hours, the motion sensors and camera system detects any motion around the parcel receptacle, identifying potential security threats.
Illumination: The system may activate built-in lights to illuminate the area, deterring potential intruders.
Alert: The speaker system may address the detected presence with a message such as, “May I help you? I might sound the alarm and call the police now,” to confront the intruder and signal monitoring.
Response: The combination of sudden illumination and vocal alert typically deters the intruder, enhancing safety and preventing unauthorized access.

### Automated Locking After Package Delivery

### Process:

Initial Delivery: Delivery personnel place a package inside the unlocked parcel receptacle.
Confirmation and Security: AI programs confirm the delivery, and the system's controller automatically locks the receptacle to secure its contents.
Resident Retrieval: The resident retrieves the package upon returning home.
Subsequent Deliveries: If a package is already inside, delivery personnel must use a code or security solution to authenticate themselves for access.

### Automated Unlocking for Empty Receptacle

### Process:

Regular Evaluation: The system regularly evaluates the contents inside the receptacle using integrated sensors.
Determination: Sensors determine if the receptacle is empty.
Automated Unlocking: If empty, the microcontroller automatically unlocks the receptacle, ensuring it is ready to receive new packages without additional actions from delivery personnel.

### Technological Integration

The DoorBox integrates several advanced technologies to enhance its functionality and offer its benefits.
AI and ML Algorithms: For real-time decision-making, facial and image recognition, analysis of data from its various sensors, and predictive analysis.
IoT Connectivity: Utilizing RFID, Bluetooth, Wi-Fi, NFCs, and other wired and wireless technologies for seamless communication and control.
Biometric and Other Security: Fingerprint, Bluetooth and various advanced technologies are utilized for authentication and recognition for secure access.
GPS Tracking: For real-time location monitoring of the receptacle.
Photoelectric and Motion Sensors: For movement around the receptacle.
Two-Way Audio Communication: For interactive communication.

The DoorBox is a comprehensive solution that leverages AI, IoT, and ML technologies to provide a secure, automated, and user-friendly experience for parcel management. Its advanced features ensure safety, convenience, and efficiency, making it an ideal choice for modern parcel reception and management needs.

Other Scenarios and Features: The scenarios described above are just examples that provide a glimpse into the capabilities and potential of our technology-enabled Smart DoorBox. The integration of AI, IoT, and ML, along with one or more of numerous sensors and electronic devices such as Motion sensors, Lidar sensors, ultrasonic sensors, Bluetooth, Wireless device, accelerometers, gyrometers, cameras, and micro-controllers with IoT capabilities, can accomplish a rich variety of features and functionalities. Some of these features include:

Pre-authenticated Access: The system can store images of previously authenticated individuals, allowing for automatic recognition and unlocking when they approach the DoorBox. This ensures that family members or trusted or authenticated delivery personnel can access the parcel receptacle without additional steps, streamlining the process and enhancing convenience.

Familiarity-based Responses: The DoorBox stores images of household members and can be programmed to perform specific functions when these individuals' approach. For example, it can greet them by name, unlock the receptacle, or activate certain features tailored to the individual's preferences. This personalization enhances the user experience by making interactions more intuitive and seamless.

Security Alerts: The system is designed to recognize unrecognized individuals and trigger alerts and notifications to the homeowner. This feature enhances security by providing real-time warnings and can be programmed to issue verbal challenges or alert authorities, depending on the situation. This proactive security measure helps prevent unauthorized access and potential theft.

Intruder Deterrence: During suspicious activities, particularly at night, the DoorBox can activate lights and issue vocal warnings to scare away potential intruders. For example, if motion is detected near the receptacle during wee hours of the day, the system might say, “You are being recorded. Please leave the area.” Such responses are intended to deter malicious activities and ensure the security of the premises.

Human-like Actions: Acting as a digital doorman, the DoorBox can perform various tasks such as greeting visitors, locking/unlocking the receptacle, and providing information. It uses its integrated camera, speaker, touch screen display, motion sensors, and lights to simulate human-like interactions, enhancing user experience and operational efficiency. This capability makes it not only a functional security device but also a friendly interface for everyday interactions.

Smart Home Integration: The DoorBox is compatible with smart home devices like Google Alexa and can integrate seamlessly into existing smart home ecosystems. This allows users to control the DoorBox remotely through mobile apps or desktop applications, set schedules, receive notifications, and interact with the device using voice commands, adding an extra layer of convenience and functionality.

Bluetooth and Wi-Fi Connectivity: The Bluetooth and Wi-Fi can be configured and integrated with the AI, IoT, and ML systems, allowing the DoorBox to be controlled using a mobile app, desktop-based solutions, or other applications. This connectivity facilitates easy setup, configuration, and remote control, ensuring seamless integration with other devices and enhancing the overall user experience.

Image Processing: The system employs advanced face and image recognition software to capture and authenticate images, enhancing security and access control. When the system recognizes an authorized individual, it can activate features such as unlocking the receptacle, turning on lights, or enabling two-way communication. This technology ensures that only authorized individuals can access the contents of the receptacle, significantly reducing the risk of unauthorized access.

Theft Prevention: A GPS module monitors the parcel receptacle's location, and if it is moved from its designated area, the system triggers an alarm and sends notifications. Additionally, sensors such as accelerometers, gyroscopes, and magnetometers detect suspicious movements, unusual vibrations, ensuring the receptacle remains secure. If tampering or unauthorized movement is detected, the system can sound an alarm and notify the homeowner immediately, providing real-time theft prevention.

Content-based Locking/Unlocking: The system uses sensors to evaluate the contents inside the parcel receptacle. If the receptacle is empty, it automatically unlocks for new deliveries. Conversely, if a package is inside, the receptacle remains locked until authenticated access is provided. This feature ensures that the receptacle is always ready to receive deliveries without compromising security.

Voice Assistance: Integrated speaker and microphone systems allow the DoorBox to interact with or authenticate delivery personnel and residents, providing instructions and acknowledgments. For example, it can guide delivery personnel on how to use the receptacle or inform residents about the status of their deliveries. This interaction ensures proper use of the system and enhances the overall user experience.

Multi-functional PCB Integration: The PCB integrates various components such as cameras, Motion sensors, displays, SD cards, audio power amplifiers, relays, locking mechanisms, and more. This comprehensive integration ensures that the parcel receptacle offers a wide range of functionalities, making it a versatile solution for different user needs and scenarios.

Power Management: Efficient power management options, including battery or solar power, ensure the system remains operational even during power outages. Solar power options contribute to the sustainability and energy efficiency of the system, while battery backups ensure continuous operation, enhancing reliability. Our power optimization circuit minimizes sleep current consumptions to extend the standby battery time significantly.

Customizable Notifications: Users can customize notifications and alerts through a mobile app or desktop application, tailoring the system to their specific preferences. For instance, users can set preferences for notification types, delivery status updates, security alerts, and more. This customization ensures that users stay informed and can manage their deliveries and security more effectively.

Environmental Adaptability: The system can adapt to different environmental conditions, ensuring reliability and security in various settings. Whether in extreme weather conditions or varying light levels, the DoorBox adjusts its operations to maintain optimal performance and security.

Tamper Detection: The system includes tamper detection features that trigger alarms and notifications if unauthorized attempts to access or move the parcel receptacle are detected. This real-time security alert helps protect against tampering and theft, providing peace of mind to the user.

Automated Reporting: The system can generate automated reports on delivery and retrieval activities, offering detailed logs for chain of custody, transparency and accountability. These reports can be accessed via the mobile app or desktop application, providing users with a comprehensive overview of all interactions with the parcel receptacle.

Integration with External Security Systems: The DoorBox can optionally integrate with existing home security systems, providing a unified and comprehensive security solution for the property. This integration ensures that all security measures work together seamlessly, enhancing overall property protection and providing a more robust security setup.

Wi-Fi and Network Security Monitoring: The electronics and PCBs inside the wireless parcel receptacle can be configured to connect to the Wi-Fi or wireless network of the parcel recipient. If the parcel receptacle gets disconnected from the Wi-Fi or wireless network, or if the signal strength varies significantly, this can suggest a suspicious event such as someone stealing or tampering with the parcel receptacle. In such cases, the system can treat the event as a potential theft and trigger alarms and notifications to alert the parcel recipient and take appropriate security measures.

Number of Users Who Can Access Mobile App: The DoorBox allows multiple users to access the mobile app, enabling family members or trusted individuals to manage and monitor deliveries. This feature is particularly useful for households with multiple occupants or for businesses that require shared access to delivery information.

Remote Lock/Unlock: Users can remotely lock or unlock the DoorBox via the mobile app, ensuring secure access from anywhere. This feature is particularly useful for granting access to delivery personnel or trusted individuals while the user is away from home.

Internal Camera Shows Received Packages: An internal camera allows users to view received packages inside the DoorBox, providing visual confirmation of deliveries. This feature ensures that users can verify the presence and condition of packages without opening the receptacle. This data can also be useful for analytics purposes and shows the purchasing patterns and sources and frequency of purchases by the resident allowing DoorBox to offer cost-saving coupons and other useful services.

External Camera Shows Delivery Person & Household Demography: An external camera captures images or video of the delivery person, enhancing security and providing a record of who delivered the package. This feature is particularly useful for identifying delivery personnel and ensuring accountability. Additionally, DoorBox can get valuable demographic data of the household such the number of residents, their age, gender and their purchasing patterns and interests, whether they have a pet, etc. and this information can be used for analytics and for offering cost-saving coupons to them.

Instant Mobile Notifications: Users receive instant mobile notifications for delivery events, security alerts, and system status updates, keeping them informed in real-time. This feature ensures that users are always aware of any activity related to their DoorBox.

Advanced AI Security: The DoorBox employs advanced AI algorithms to enhance security, detect suspicious activities, and prevent unauthorized access. This feature ensures that the system continuously learns and adapts to potential threats, providing robust protection.

On-Demand Status Updates: Users can request on-demand status updates via the mobile app, providing real-time information of all the readings such us battery levels, Wi-Fi strength, etc. from their DoorBox and its cameras and all other sensors. This feature ensures that users can check the status of their deliveries and the system at any time.

Real-Time Wi-Fi, Battery, & Temperature Monitoring: The system monitors Wi-Fi connectivity, battery levels, and internal temperature in real-time, ensuring optimal performance and alerting users to any issues. This feature ensures that the DoorBox operates efficiently and reliably under all conditions.

Weather-Proof Touchscreen: The DoorBox features a weather-proof touchscreen, allowing users to interact with the system in various environmental conditions. This feature ensures that the DoorBox remains functional and accessible regardless of weather conditions.

Utilizing Customer Purchase Data: The system can analyze customer purchase data to offer personalized recommendations and services. This feature enhances the user experience by providing tailored suggestions based on individual preferences and purchase history.

Savings with Personalized Coupons: Users can receive personalized coupons based on their purchase history, providing savings and enhancing the user experience. This feature ensures that users benefit from targeted promotions and discounts.

Dedicated Web Portal: Users can access a dedicated web portal for managing the DoorBox, viewing delivery history, and configuring settings. This feature provides an additional platform for users to monitor and control their DoorBox, enhancing accessibility and usability.

Centralized Data Control: All data related to deliveries, security events, and system status is centralized, providing users with easy access and control. This feature ensures that users can efficiently manage and analyze all information related to one or more of the DoorBox they own.

Real-Time GPS via Web Portal: The web portal provides real-time GPS tracking of the DoorBox, enhancing security and allowing users to monitor its location. This feature ensures that users can track the DoorBox and receive alerts if it is moved from its designated area.

Image & Video History: The system stores image and video history of delivery events, providing users with a comprehensive record for security and reference. This feature ensures that users have access to detailed visual records of all interactions from one or more of the DoorBox they own.

### AI Shopping Engine: Auto-Sourcing Coupons From DoorBox Purchase Analytics

The AI Shopping Engine is an advanced system designed to automatically source and apply coupons based on purchase analytics derived from data collected through the DoorBox delivery system. At its core, the AI Shopping Engine manages the integration of various data sources, analyzes the information, and generates coupon recommendations using machine learning algorithms. This engine continuously learns and adapts to enhance the accuracy and relevance of its recommendations.

The DoorBox device, equipped with internal cameras, captures images of delivered packages, which are then processed using image recognition technology to identify the brands and products received. These images are stored and linked to the respective customer's purchase history. Additionally, the system is configured to receive and parse order confirmation emails from vendors like Amazon, Walmart, Costco, Target, Petco, and Chewy, etc., extracting relevant purchase information such as product names, unit prices, quantities, and purchase dates.

The system integrates data from the DoorBox images and order confirmation emails to create a comprehensive record of customer purchases. This integrated data provides insights into purchasing behavior and preferences, which are crucial for generating personalized coupon recommendations. The data-driven coupon insights module analyzes the collected data to identify trends and patterns in purchasing behavior, determining the most relevant coupons for each customer. These insights are categorized into various product segments like groceries, pet supplies, and baby products, etc.

Example use cases illustrate the system's effectiveness: for groceries, a customer frequently purchasing fresh produce from Amazon Fresh would receive relevant coupons for fresh produce from brands like Amazon Fresh and Walmart Grocery or their competitors, covering products like milk and fresh produce. For pet supplies, a customer regularly buying pet products from Petco and Chewy would receive coupons for popular pet care products from brands like Petco and Chewy or their competitors, including items like Frontline Plus and NexGard. Similarly, a customer with a history of purchasing baby products from Buy Buy Baby and Albee Baby would receive coupons for essential baby items from brands like Buy Buy Baby and Albee Baby or their competitors, covering products like Enfamil and Pampers. This comprehensive system ensures that customers benefit from targeted promotions and discounts tailored to their specific purchasing habits.

### Dynamic API and GPS-Integrated Autonomous Delivery System With Real-Time Generative AI Adjustments

The system integrates a Dynamic API and GPS with one or more generative AI applications to enhance the delivery process, incorporating autonomous delivery capabilities. This method uses various data inputs, processes them through an API linked to AI platforms, and provides real-time delivery adjustments and insights. The aim is to optimize deliveries based on dynamic environmental and situational data, leveraging real time data from delivery personnels or autonomous delivery vehicles for an efficient end-to-end delivery solution.

The system utilizes a Dynamic API that interfaces with AI platforms such as OpenAI and Google Gemini among others. This API facilitates the processing of various types of data (images, videos, text, audio, etc.) to generate real-time delivery insights and adjustments. The collected data from multiple sources provides comprehensive information on the delivery environment and context, which is then processed through the Dynamic API to extract relevant information and insights. This processing step leverages the AI capabilities of platforms like OpenAI and Google Gemini to perform complex data analysis.

The processed data generates actionable outputs that assist in real-time decision-making. These outputs can include notifications, delivery route adjustments, and other relevant delivery insights. The system uses GPS data to track and optimize delivery routes, integrating with generative AI to adjust delivery plans dynamically based on real-time data.

The system incorporates autonomous delivery vehicles for end-to-end delivery solutions, operating without human intervention and using AI and GPS data to navigate and deliver packages. These autonomous delivery vehicles are equipped with sensors, Bluetooth, wireless devices, Cameras, and GPS to navigate delivery routes, with the AI system continuously monitoring the delivery environment and adjusting the vehicle's route and behavior in real-time. Scenario mapping using GPS data provides a visual representation of delivery routes and points, ensuring packages are delivered to the correct houses within a neighborhood (e.g., Sam's House and John's House or more).

The process flow begins with input collection, where data inputs (images, videos, text, audio) are gathered from various sources, including delivery personnel, DoorBox images, autonomous delivery vehicles, and GPS data. The Dynamic API processes the collected data by interfacing with AI platforms to analyze and extract actionable insights. Based on this analysis, the system generates outputs such as real-time delivery notifications, route adjustments, lock/unlock of DoorBox or its controls, and delivery confirmations. Autonomous vehicles are then deployed to execute deliveries, with the system monitoring and controlling these vehicles to ensure efficient and accurate deliveries. The system uses GPS data to monitor and optimize delivery routes, ensuring efficient and accurate deliveries.

Example use cases illustrate the system's effectiveness. For instance, during an Amazon delivery, an Amazon truck driver delivers a package, and the system captures an image of the driver and the package. This image is processed to confirm the delivery and update the customer's delivery status. In another scenario, the system maps delivery routes within a neighborhood and dynamically adjusts the routes based on real-time data to ensure packages are delivered to the correct addresses efficiently.

Additionally, an autonomous delivery vehicle can be dispatched to deliver packages, navigating using GPS data and AI-driven route optimization to ensure timely and accurate deliveries.

### Fully Automated Mobile App & Interactive Dashboard of DoorBox.ai

The system involves a fully automated mobile application and an interactive dashboard for DoorBox.ai, designed to provide comprehensive delivery management and verification. The mobile application interfaces with the Smart DoorBox system, offering users real-time updates and control over their DoorBox and deliveries into DoorBox. It provides functionalities such as package notifications, box status monitoring, and delivery confirmations. The home screen of the app displays the current status of the DoorBox, internal camera feed, and recent notifications, allowing users to see the lock status, contents, and receive alerts.

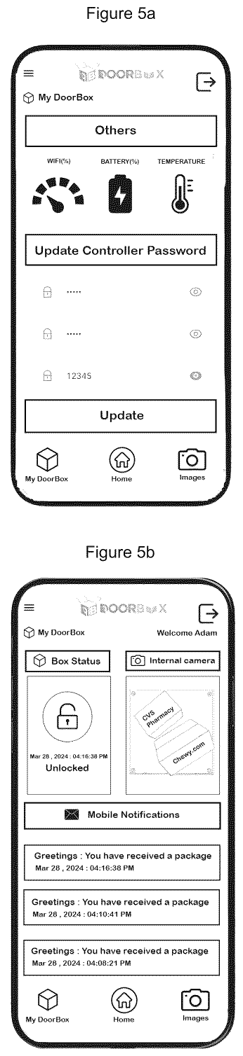

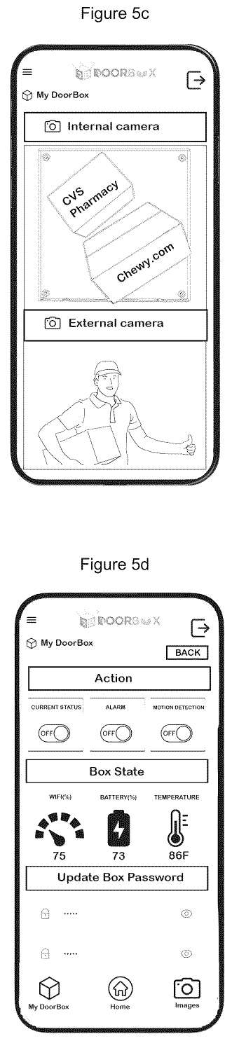

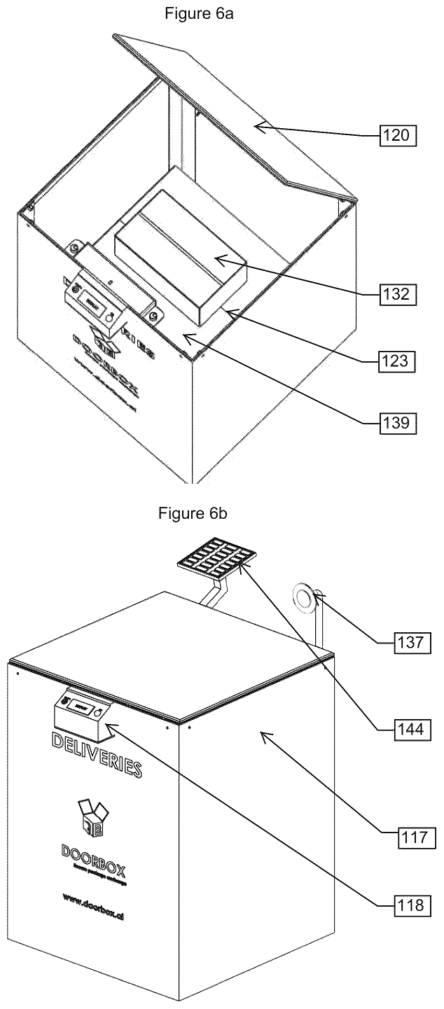

The My DoorBox (FIGS. 5a to 5d) section enables users to access detailed settings and information, including controlling the current status (e.g., lock/unlock), setting alarms, enabling motion detection, and monitoring indicators like Wi-Fi connectivity, battery level, and internal temperature. Users can also update the DoorBox password for enhanced security.

The interactive dashboard provides detailed delivery confirmation, including visual proof with timestamped images of delivery and pickup events, helping users verify delivery details such as where and what was delivered, who delivered it, and who picked it up. The system captures and displays images of delivered packages inside the DoorBox, along with timestamps and package details. It also captures images of delivery personnel at the time of delivery and the person who picks up the package, ensuring secure retrieval and providing proof of pickup. Additionally, the system displays essential customer details such as name, address, and contact information, ensuring accurate and personalized service, crucial for delivery verification, chain of custody documentation and customer support.

The process flow begins with data collection through internal cameras, sensors, and user inputs via the mobile app, including images of packages, delivery personnel, and pickup events. Users receive real-time notifications about delivery events, including package arrival, box status changes, and security alerts.

Images captured by the internal camera are processed and securely stored in the cloud, with timestamps and metadata attached for accurate record-keeping. The interactive dashboard provides users with a comprehensive view of their delivery history, including visual proof and detailed logs of all delivery-related events. Users can control various aspects of their DoorBox through the mobile app, such as setting alarms, enabling motion detection, changing passwords and access codes, and updating security settings.

Example use cases illustrate the system's effectiveness: for package delivery verification, a user receives a notification of package delivery and can open the app to see an image of the package inside the DoorBox, confirming its arrival. For security monitoring, a user receives an alert that the DoorBox was accessed and can check the app to see who picked up the package along with a timestamped image. For environmental monitoring, the app shows that the internal temperature of the DoorBox is rising, allowing the user to take appropriate action to ensure the safety of temperature-sensitive deliveries.

1. A system for securely receiving, returning, or exchanging a parcel, comprising:
a parcel receptacle comprising a containment portion to store the parcel and a lid for accessing the containment portion; and a security system comprising a locking system, a security notification unit, and a tethering means, the locking system comprising one or more locking mechanisms configured to releasably lock the lid, the security notification unit, in electronic communication with an electronic device of a receiver of the parcel, comprises: an input means to receive credentials for unlocking the lid, and one or more sensors to monitor one or more activities in the containment portion and around the parcel receptacle, the security notification unit is configured to send a notification to the electronic device of the receiver in the instance of a change in one or more activities detected by the one or more sensors, the tethering means to secure the parcel receptacle and trigger the security system in the instance of a security breach.

2. The system for securely receiving, returning, or exchanging a parcel as claimed in claim 1, wherein the parcel receptacle comprises a solar panel on at least one surface of the parcel receptacle, wherein the solar energy harnessed through the solar panel powers the security system.

3. The system for securely receiving, returning, or exchanging a parcel as claimed in claim 1, wherein the one or more sensors comprise a motion sensor, a first camera, and a second camera, and wherein the first camera and the second camera are positioned to capture the containment portion and the surroundings of the parcel receptacle.

4. The system for securely receiving, returning, or exchanging a parcel as claimed in claim 3, wherein the security notification unit is configured to lock and unlock the lid based on the inputs received from an electronic device.

5. The system for securely receiving, returning, or exchanging a parcel as claimed in claim 1, wherein the security notification unit is configured to: capture one or more pictures using the first camera and the second camera, and notify the electronic device of the receiver in the instance of the change in one or more activities.

6. The system for securely receiving, returning, or exchanging a parcel as claimed in claim 5, wherein the one or more activities include a parcel placed in the containment portion, a change in temperature within the containment portion, a subject approaching the parcel receptacle, and a security breach.

7. The system for securely receiving, returning, or exchanging a parcel as claimed in claim 6, wherein the security breach includes the movement of the parcel receptacle from its installation location.

8. The system for securely receiving, returning, or exchanging a parcel as claimed in claim 1, wherein the parcel receptacle is tamper-proof and weather resistant.

9. The system for securely receiving, returning or exchanging a parcel as claimed in claim 1, wherein the parcel receptacle further comprises a temperature control system operable to regulate the temperature within the containment portion.

10. The system for securely receiving, returning or exchanging a parcel as claimed in claim 1, wherein the input means comprises a keypad and a display unit.

11. The system for securely receiving, returning or exchanging a parcel as claimed in claim 10, wherein the parcel receptacle comprises a solar panel on at least one surface of the parcel receptacle, wherein the solar energy harnessed through the solar panel powers the security system, and wherein the display unit includes a battery level indicator.

12. The system for securely receiving, returning or exchanging a parcel as claimed in claim 1, wherein the parcel receptacle is surrounded by a flexible water repellant fabric, and wherein a wire mesh is embedded within the flexible water repellant fabric.

13. The system for securely receiving, returning or exchanging a parcel as claimed in claim 1, wherein the tethering means is wireless.

14. The system for securely receiving, returning or exchanging a parcel as claimed in claim 1, wherein the parcel receptacle comprises a tampering alarm to raise an alarm in the instance of a security breach.

15. The system for securely receiving, returning or exchanging a parcel as claimed in claim 1, wherein the parcel receptacle comprises one or more light sources positioned in the containment portion or on the parcel receptacle.

16. The system for securely receiving, returning or exchanging a parcel as claimed in claim 1, wherein the tethering means secures the parcel receptacle to a wall mount.

17. The system for securely receiving, returning or exchanging a parcel as claimed in claim 1, further comprises an indicator on the lid to indicate at least one of presence of a parcel or the locked position of the lid.

18. A system for securely receiving, returning, or exchanging a parcel, comprising: one or more parcel receptacles each comprising a containment portion to store the parcel and a lid for accessing the containment portion; and a security system comprising a locking system, a security notification unit, and a tethering means, the locking system comprising one or more locking mechanisms configured to releasably lock the lid, the security notification unit, in electronic communication with an electronic device of a receiver of the parcel, comprises an input means to receive credentials for unlocking the lid, and one or more sensors to monitor one or more activities in the containment portion and around the parcel receptacle, the security notification unit is configured to send a notification to the electronic device of the receiver in the instance of a change in one or more activities detected by the one or more sensors, the tethering means to secure the parcel receptacle and trigger the security system in the instance of a security breach.

19. The system for securely receiving, returning, or exchanging a parcel as claimed in claim 18, wherein each of the one or more parcel receptacles comprises of a top member, a bottom member, and collapsible side members supported by a plurality of rods that are removably attached to one or more parcel receptacles.

20. The system for securely receiving, returning, or exchanging a parcel as claimed in claim 19, wherein at least one of the one or more parcel receptacles are flexible in shape.

21.-43 (canceled)
